(19) United States
(12) Patent Application Publication
(10) Pub. No.: US 2025/0271722 A1
(43) Pub. Date: Aug. 28, 2025

(54) VARIABLE LIGHT TRANSMISSION DEVICE COMPRISING MICROCELLS

(71) Applicant: E INK CORPORATION, Billerica, MA (US)

(72) Inventors: Yu XIA, Acton, MA (US); Dirk HERTEL, Quincy, MA (US); Dan LUO, Lexington, MA (US); Stephen J. TELFER, Arlington, MA (US)

(21) Appl. No.: 19/059,731

(22) Filed: Feb. 21, 2025

Related U.S. Application Data
(60) Provisional application No. 63/558,881, filed on Feb. 28, 2024.

(51) Int. Cl. G02F 1/16757; G02F 1/1676

(52) U.S. Cl. CPC G02F 1/16757; G02F 1/1676

(57) ABSTRACT

A variable light transmission device is disclosed, the variable light transmission device comprising two light transmissive electrode layers and a microcell layer having a plurality of microcells. Each of the plurality of microcells includes electrically charged pigment particles, a charge control agent, and a non-polar liquid. Upon application of an electric field, the amount of light passing through the device can be modulated.

### RELATED APPLICATIONS

This application claims priority to U.S. Provisional Patent Application No. 63/558,881 filed on Feb. 28, 2024, which is incorporated by reference in its entirety, along with all other patents and patent applications disclosed herein.

### BACKGROUND OF THE INVENTION

This invention relates to a variable light transmission device. Specifically, the invention relates to a microcell electro-optic device comprising an electrophoretic medium, the electrophoretic medium including a plurality of electrically charged pigment particles, a charge control agent, and a non-polar liquid. The electrophoretic medium is able to switch between optical states using electric fields. The variable light transmission devices can modulate the amount of light and other electromagnetic radiation passing through them. They can be used on mirrors, windows, sunroofs, and similar items. For example, the present invention may be applied to windows that can modulate infrared radiation for controlling temperatures within buildings and vehicles. Examples of electrophoretic media that may be incorporated into various embodiments of the present invention include, for example, the electrophoretic media described in U.S. Pat. Nos. 8,576,476, 11,733,557, and 12,153,322, and U.S. Patent Application Publication Nos. 2011/0199671, 2020/0355979, 2023/0100320, the contents of which are incorporated by reference herein in their entireties.

Particle-based electrophoretic displays, in which a plurality of electrically charged pigment particles move through a suspending fluid under the influence of an electric field, have been the subject of intense research and development for a number of years. Such displays can have attributes of good brightness and contrast, wide viewing angles, state bistability, and low power consumption when compared with liquid crystal displays.

The terms “bistable” and “bistability” are used herein in their conventional meaning in the art to refer to displays comprising display elements having first and second display states differing in at least one optical property, and such that after any given element has been driven by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application Ser. No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrically charged pigment particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which comprises an internal phase containing electrophoretically-mobile particles in a liquid medium, and a capsule wall surrounding the internal phase. Typically, the capsules are themselves held within a polymeric binder to form a coherent layer positioned between two electrodes. In a microcell electrophoretic display, the electrically charged pigment particles and the liquid are not encapsulated within microcapsules but instead are retained within a plurality of cavities formed within a carrier medium, typically a polymeric film. The technologies described in these patents and applications include:
(a) Electrophoretic particles, fluids, and fluid additives; see for example U.S. Pat. Nos. 7,002,728 and 7,679,814;
(b) Capsules, binders, and encapsulation processes; see for example U.S. Pat. No. 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(c) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation and color adjustment; see for example U.S. Pat. Nos. 7,075,502 and 7,839,564;
(h) Methods for driving displays; see for example U.S. Pat. Nos. 7,012,600 and 7,453,445;
(i) Applications of displays; see for example U.S. Pat. Nos. 7,312,784 and 8,009,348; and
(j) Non-electrophoretic displays, as described in U.S. Pat. No. 6,241,921.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of a non-polar liquid and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned U.S. Patent Application Publication No. 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the electrically charged pigment particles and the suspending liquid are not encapsulated within microcapsules but instead are retained within a plurality of cavities formed within a carrier medium, typically a polymeric film.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. Sec, for example, U.S. Pat. Nos. 6,130,774 and 6,172,798, and 5,872,552. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques. Thus, the resulting display can be flexible. Further, because the display medium can be printed (using a variety of methods), the display itself can be made inexpensively.

One potentially important market for electrophoretic media is windows with variable light transmission. As the energy performance of buildings and vehicles becomes increasingly important, electrophoretic media could be used as coatings on windows to enable the proportion of incident radiation transmitted through the windows to be electronically controlled by varying the optical state of the electrophoretic media. Effective implementation of such “variable transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance by using an electro-optic coating on the mirror, and (4) increased ability to use heads-up displays. Other potential applications of VT technology include privacy glass and glare-guards in electronic devices.

The art provides examples of devices comprising electrophoretic media sandwiched by electrode layers that are able to achieve a closed optical state (opaque optical state) and an open optical state (transparent optical state) and to switch between these states by application of electric fields across the electrophoretic medium. However, conventional electrophoretic devices using conventional structures and waveforms require long switching times. Furthermore, light from a bright object such as a light source in a dark ambient environment or specular reflections of the sun in a bright ambient environment, when it passes through the device may be subject to diffraction phenomena that can be visible or even disturbing to a viewer, making the devices less desirable. The inventors of the present invention unexpectedly found that devices comprising a microcell layer having the claimed architecture and the claimed arrangements of electrically charged pigment particles in the microcell achieve efficient switching between the open and close optical states and improved optical performance of the open optical state.

### SUMMARY OF THE INVENTION

In one aspect, the present invention provides a variable light transmission device comprising a first light transmissive electrode layer, a second light transmissive electrode layer, and a microcell layer. The microcell layer is disposed between the first light transmissive layer and the second light transmissive layer. Upon application of an electric field between the first light transmissive electrode layer and the second light transmissive electrode layer, the amount of light passing through the device can be modulated.

The microcell layer of the variable light transmission device comprises a plurality of microcells and a sealing layer. Each microcell of the plurality of microcells includes an electrophoretic medium, the electrophoretic medium comprising a plurality of first type of electrically charged pigment particles, a charge control agent, and a non-polar liquid. Each microcell of the plurality of microcells has a microcell opening. The sealing layer of the microcell layer spans the microcell opening of the plurality of microcells. Each microcell of the plurality of microcells comprises a microcell bottom layer, a protrusion structure, microcell walls, a midplane, and a channel. The microcell bottom layer has a microcell bottom inside surface, the microcell bottom inside surface comprising an exposed microcell bottom inside surface and an unexposed microcell bottom inside surface. The protrusion structure has a protrusion base, a protrusion surface, a protrusion apex, and a protrusion height. The protrusion structure consists of a lower part and an upper part. The protrusion apex is a point or a set of points of the protrusion structure, the point or the set of points having shorter distance from the microcell opening than all other points of the protrusion structure. The protrusion height is the distance between the protrusion base and the protrusion apex. The protrusion surface is the surface of the protrusion structure that is in contact with the electrophoretic medium not including the protrusion apex. The midplane is a plane that is parallel to the sealing layer, the midplane being located between the protrusion base and the protrusion apex, the distance between the midplane and the protrusion base being equal to half of the protrusion height, the midplane dividing the protrusion structure (217) into the lower part and the upper part.

The microcell walls have a microcell inside wall surface and a microcell wall upper surface. The microcell inside wall surface is the surface of the microcell walls of a microcell that is in contact with the electrophoretic medium. The microcell wall upper surface is a surface of the microcell walls of a microcell that is in contact with the sealing layer.

The protrusion base and the exposed microcell bottom inside surface have an intersection. The microcell inside wall surface and the exposed microcell bottom inside surface also have an intersection.

The channel has a channel height, an inner perimeter, and an outer perimeter. The channel height is half of the protrusion height. The inner perimeter of the channel is the intersection of the protrusion base and the exposed microcell bottom inside surface. The outer perimeter is the intersection of the microcell inside wall surface and the exposed microcell bottom inside surface. The unexposed microcell bottom inside surface is a part of the microcell bottom inside surface that is in contact with the protrusion base. The channel is a volume confined between the exposed microcell bottom inside surface, the protrusion surface, the microcell inside wall surface, and the midplane.

The variable light transmission device has a first outside surface and a second outside surface. The first outside surface is located on a side the variable light transmission device that is near the first light transmissive electrode layer, and the second outside surface is located on a side of the variable light transmission device that is near the second light transmissive electrode layer.

The exposed microcell bottom inside surface has an x dimension and a y dimension for a point of the outer perimeter of the channel, the x dimension being defined by a line that includes the line segment that corresponds to the shortest distance between the point of the outer perimeter of the channel and the inner perimeter of the channel, the y dimension being orthogonal to the x dimension, both the x dimension and the y dimension being on a plane of the exposed microcell bottom inside surface.

Application of the first electric field between the first light transmissive electrode layer and the second light transmissive electrode layer via a first waveform causes movement of the plurality of first type of electrically charged pigment particles towards the channel, resulting in switching of the variable light transmission device to an open optical state. The plurality of first type of electrically charged pigment particles in the open optical state are arranged in the channel to achieve varied optical density or varied visible light spectrum of the variable light transmission device across the x dimension of the exposed microcell bottom inside surface a microcell.

Application of a second electric field between the first light transmissive electrode layer and the second light transmissive electrode layer via a second waveform may cause movement of the plurality of first type of electrically charged pigment particles towards the first light transmissive electrode layer resulting in the switching of the variable light transmission device to a closed optical state, the closed optical state having lower percent transparency than the open optical state. The second waveform may comprise at least one positive voltage and at least one negative voltage. The movement of the plurality of first type of electrically charged pigment particles towards the first light transmissive electrode layer, which caused the closed optical state, has a velocity, velocity having a lateral component. The second waveform may comprise an AC waveform, the AC waveform having a duty cycle of from 5% to 45%. The second waveform may comprise a DC-offset waveform, which is formed by a superposition of a DC voltage component and an AC waveform. The second waveform may be DC-imbalanced.

The protrusion structure of a microcell may be a geometric solid selected from the group consisting of:
(a) a polygonal pyramid, the polygonal pyramid having an apex and polygon base, the polygon apex being the protrusion apex, the polygon base having 3-20 sides, and the polygon base being the protrusion base of the protrusion structure;
(b) a polygonal pyramid on a polygonal prism, the polygonal pyramid having an apex and a polygon base, the polygonal prism having a first polygon base and a second polygon base, the polygonal pyramid apex being the protrusion apex, the polygon base of the polygonal pyramid being in contact with the first polygon base of the polygonal prism, the second polygon base of the polygonal prism being the protrusion base of the protrusion structure, the polygon base of the polygonal pyramid and the first and second polygon bases of the polygonal prism having the same number of sides, the polygon base of the polygonal pyramid and the first and second polygon bases of the polygonal prism having 3-20 sides;
(c) a cone having an apex and a base, the apex of the cone being the protrusion apex, the base of the cone being circular, and the base of the cone being the protrusion base;
(d) a cone on a cylinder, the cone having an apex and a base, the base of the cone being circular, the apex of the cone being the protrusion apex, the cylinder having a first base and a second base, the first base and the second base being circular, the base of the cone being in contact with the first base of the cylinder, and the second base of the cylinder being the protrusion base of the protrusion structure;
(c) a frustum of polygonal pyramid, the frustum of polygonal pyramid having a first polygon base and a second polygon base, the first polygon base having a smaller area than the second polygon base, the first polygon base being the protrusion apex and the second polygon base being the protrusion base, the first and second polygon bases of the frustrum of the polygonal pyramid having 3-20 sides;
(f) a frustum of polygonal pyramid on an polygonal prism, the frustum of polygonal prism having a first polygon base and a second polygon base, the first polygon base of the frustum of polygonal pyramid having a smaller area than the second polygon base of the frustum of polygonal pyramid, the polygonal prism having a first polygon base and a second polygon base, the first polygon base of the frustum of polygonal pyramid being the protrusion apex, the second polygon base of the polygonal pyramid being in contact with the first polygon base of the polygonal prism, the second polygon base of the polygonal prism being the protrusion base, the first and second polygon bases of the frustum of polygonal pyramid and the first and second polygon bases of the polygonal prism having the same number of sides, the first and second polygon bases of the frustum of polygonal pyramid and the first and second polygon bases of the polygonal prism the first polygon base having 3-20 sides;
(g) a frustum of cone, the frustum of cone having a first base and a second base, the first base of the frustum of cone having a smaller area than the second base of the frustum of cone, the first base of the frustum of cone being the protrusion apex and the second base of the frustum of cone being the protrusion base, the first and second bases of the frustrum of the cone being circular;
(h) a frustum of cone on a cylinder, the frustum of cone having a first base and a second base, the first base of the frustum of cone having a smaller area than the second base of the frustum of cone, the cylinder having a first base and a second base, the first and second bases of the frustum of cone and the first and second bases of the cylinder being circular, the first base of the frustum of cone being the protrusion apex, the second base of the frustum of cone being in contact with the first base of the cylinder, and the second base of the cylinder being the protrusion base;
(i) a polygonal pyramid on a frustum of polygonal pyramid, the polygonal pyramid having an apex and a polygon base, the frustum of polygonal pyramid having a first polygon base and a second polygon base, the first base having smaller area than the second base, the polygonal pyramid apex being the protrusion apex, the polygon base of the polygonal pyramid being in contact with the first polygon base of the frustum of polygonal pyramid, the second polygon base of the frustum of polygonal pyramid being the protrusion base of the protrusion structure, the polygon base of the polygonal pyramid and the first and second polygon bases of the polygonal prism having the same number of sides, the polygon base of the polygonal pyramid and the first and second polygon bases of the frustum of polygonal pyramid having 3-20 sides;
(j) a cone on a frustum of cone, the cone having an apex and a base, the base of the cone being circular, the apex of the cone being the protrusion apex, the frustum of cone having a first base and a second base, the first base and the second base being circular, the first base having smaller area than the second base, the base of the cone being in contact with the first base of the frustum of cone, and the second base of the frustum of cone being the protrusion base of the protrusion structure;
(k) a first frustum of polygonal pyramid on a second frustum of polygonal pyramid, the first frustum of polygonal pyramid having a first polygon base and a second polygon base, the first polygon base of the first frustum of polygonal pyramid having a smaller area than the second polygon base of the first frustum of polygonal pyramid, the second frustum of polygonal pyramid having a first polygon base and a second polygon base, the first polygon base of the second frustum of polygonal pyramid having smaller area than the second polygon base of the second frustum of polygonal pyramid, the first polygon base of the first frustum of polygonal pyramid being the protrusion apex, the second polygon base of the first frustum of polygonal pyramid being in contact with the first polygon base of the second frustum of polygonal pyramid, the second polygon base of the second frustum of polygonal pyramid being the protrusion base, the first and second polygon bases of the first frustum of polygonal pyramid and the first and second polygon bases of the second frustum of polygonal pyramid having the same number of sides, the first and second polygon bases of the first frustum of polygonal pyramid and the first and second polygon bases of the second frustum of polygonal pyramid having 3-20 sides, the slope of the first frustum of polygonal pyramid being larger than the slope of the second frustum of polygonal pyramid or the slope of the first frustum of polygonal pyramid being smaller than the slope of the second frustum of polygonal pyramid;
(l) a first frustum of cone on a second frustum of cone, the first frustum of cone having a first base and a second base, the first base of the first frustum of cone having a smaller area than the second base of the first frustum of cone, the second frustum of cone having a first base and a second base, the first base of the second frustum of cone having smaller area than the second base of the second frustum of cone, the first base of the first frustum of cone being the protrusion apex, the second base of the first frustum of cone being in contact with the first base of the second frustum of cone, the second base of the second frustum of cone being the protrusion base, the first and second bases of the first frustum of cone and the first and second bases of the second frustum of cone having the same number of sides, the first and second bases of the first frustum of cone and the first and second bases of the second frustum of cone having 3-20 sides, the slope of the first frustum of cone being larger than the slope of the second frustum of cone or the slope of the first frustum of cone being smaller than the slope of the second frustum of cone.
(a) If the protrusion structure is a polygonal pyramid, the polygonal pyramid may have a slope of from 5 degrees to 20 degrees, from 2 degrees to 20 degrees, or from 3 degrees to 18 degrees; (b) if the protrusion structure is a polygonal pyramid on a polygonal prism, the polygonal pyramid has a slope of from 5 degrees to 20 degrees, from 2 degrees to 20 degrees, or from 3 degrees to 18 degrees; (c) if the protrusion structure is a cone, the cone has a slope of from 5 degrees to 20 degrees, from 2 degrees to 20 degrees, or from 3 degrees to 18 degrees; (d) if the protrusion structure is a cone on a cylinder, the cone has a slope of from 5 degrees to 20 degrees, from 2 degrees to 20 degrees, or from 3 degrees to 18 degrees; (e) if the protrusion structure is a frustum of polygonal pyramid, the frustum of polygonal pyramid has a slope of from 5 degrees to 20 degrees, from 2 degrees to 20 degrees, or from 3 degrees to 18 degrees; (f) if the protrusion structure is a frustum of polygonal pyramid on an polygonal prism, the frustum of polygonal pyramid has a slope of from 5 degrees to 20 degrees, from 2 degrees to 20 degrees, or from 3 degrees to 18 degrees; (g) if the protrusion structure is a frustum of cone, the frustum of cone has a slope of from 5 degrees to 20 degrees, from 2 degrees to 20 degrees, or from 3 degrees to 18 degrees; (h) if the protrusion structure is a frustum of cone on a cylinder, the frustum of cone has a slope of from 5 degrees to 20 degrees, from 2 degrees to 20 degrees, or from 3 degrees to 18 degrees; (i) if the protrusion structure is a polygonal pyramid on a frustum of polygonal pyramid, the polygonal pyramid has a slope of from 5 degrees to 20 degrees, from 2 degrees to 20 degrees, or from 3 degrees to 18 degrees, and the frustum of polygonal pyramid has a slope of from 5 degrees to 20 degrees, from 2 degrees to 20 degrees, or from 3 degrees to 18 degrees; (j) if the protrusion structure is a cone on a frustum of cone, the cone has a slope of from 5 degrees to 20 degrees, from 2 degrees to 20 degrees, or from 3 degrees to 18 degrees, and the frustum of cone has a slope of from 5 degrees to 20 degrees, from 2 degrees to 20 degrees, or from 3 degrees to 18 degrees; (k) if the protrusion structure is a first frustum of polygonal pyramid on a second frustum of polygonal pyramid, the first frustum of polygonal pyramid has a slope of from 5 degrees to 20 degrees, from 2 degrees to 20 degrees, or from 3 degrees to 18 degrees, and the second frustum of polygonal pyramid has a slope of from 5 degrees to 20, from 2 degrees to 20 degrees, or from 3 degrees to 18 degrees; (l) if the protrusion structure is a first frustum of cone on a second frustum of cone, the first frustum of cone has a slope of from 5 degrees to 20 degrees, from 2 degrees to 20 degrees, or from 3 degrees to 18 degrees, and the second frustum of cone has a slope of from 5 degrees to 20 degrees, from 2 degrees to 20 degrees, or from 3 degrees to 18 degrees.

In one aspect of the present invention, the angle between the microcell inside wall surface and the microcell bottom inside surface is larger than 90 degrees, and the combination of the channel and the protrusion structure of a microcell may be a geometric solid selected from the group consisting of (a) a cylinder, (b) a cone, (c) a polygonal pyramid having a polygon base, the polygon base having from 3 to 20 sides, (d) a polygonal prism, the polygonal prism having two polygon bases, the polygon bases having from 3 to 20 sides, (e) a frustum of cone, and (f) a frustum of polygonal pyramid, the frustum of polygonal pyramid having a first and a second bases, the first and second bases being polygons having from 3 to 20 sides.

In one aspect of the present invention, the plurality of first type of electrically charged pigment particles in an open optical state may be arranged in a channel of a microcell with a horizontal distribution that is reduced across the x dimension of the exposed microcell inside surface from the outer perimeter of the channel of the microcell to the inner perimeter of the microcell. The plurality of first type of electrically charged pigment particles in an open optical state may be arranged in a channel of a microcell with a horizontal distribution that is gradually reduced across the x dimension of the exposed microcell inside surface from the outer perimeter of the channel of the microcell to the inner perimeter of the microcell.

The arrangement of the plurality of first type of electrically charged pigment particles in an open optical state has a horizontal distribution that is gradually reduced across the x dimension of the exposed microcell inside surface from the outer perimeter of the channel of the microcell to the inner perimeter of the microcell, may be achieved via the application of an electric field between the first light transmissive electrode layer and the second light transmissive electrode layer that causes a movement of the plurality of first type of electrically charged pigment particles towards the second light transmissive electrode layer with a velocity, the velocity having a lateral component.

Each of the plurality of first type of electrically charged pigment particles comprises a first light absorbing pigment. The plurality of the first type of electrically charged pigment particles has a first absorption spectrum. The plurality of the first type of electrically charged pigment particles may absorb (a) in the visible light region of the electromagnetic radiation (wavelengths 380-780 nm), or (b) in the near infrared region of the electromagnetic radiation (wavelengths 780-2500 nm).

The electrophoretic medium of the variable light transmission device may comprise, in addition to the plurality of first type of electrically charged pigment particles, a plurality of second type of electrically charged pigment particles. Each of the plurality of first type of electrically charged pigment particles have a first charge polarity, and each of the plurality of second type of electrically charged pigment particles have a second charge polarity. The first charge polarity may be the same as the second charge polarity. The first type of electrically charged pigment particles may have different zeta potential from the second type of electrically charged pigment particles. Each of the plurality of first type of electrically charged pigment particles and each of the second type of electrically charged pigment particles may be positive and the zeta potential of the first type of electrically charged pigment particles may be higher than the zeta potential of the second type of electrically charged pigment particles. Each of the plurality of first type of electrically charged pigment particles and each of the plurality of second type of electrically charged pigment particles may be negative and the zeta potential of the first type of electrically charged pigment particles may be lower than the zeta potential of the second type of electrically charged pigment particles. If each of the plurality of first type of electrically charged pigment particles and each of the plurality of second type of electrically charged pigment particles are negatively charged, lower zeta potential of the first type of electrically charged pigment particles means that the zeta potential of the first type of electrically charged pigment particles is more negative than the zeta potential of the second type of electrically charged pigment particles. That is, if, for example, the zeta potential of the first type of electrically charged pigment particles is −15 eV, the zeta potential of the second type of electrically charged pigment particles may be −10 eV. The plurality of first type of electrically charged pigment particles may have an average particle size that is smaller than the average particle size of the plurality of second type of electrically charged pigment particles.

In one example, each of the plurality of first type of electrically charged pigment particles comprises a first light absorbing pigment, and each of the plurality of second type of electrically charged pigment particles comprises a second light absorbing pigment. The first type of electrically charged pigment particles has a first absorption spectrum, and the second type of electrically charged pigment particles has a second absorption spectrum, wherein the first absorption spectrum is different from the second absorption spectrum. The first absorption spectrum (or the second absorption spectrum) may be (a) in the visible light region of the electromagnetic radiation (wavelengths 380-780 nm), or (b) in the near infrared region of the electromagnetic radiation (wavelengths 780-2500 nm). The first absorption spectrum (or the second absorption spectrum) may also be (c) in the ultraviolet light region of the electromagnetic radiation (wavelengths 100-380 nm) or (d) in the infrared region of the electromagnetic radiation (wavelengths 780 nm-1 mm).

The plurality of first type of electrically charged pigment particles may have an average particle size that is smaller than the average particle size of the plurality of second type of electrically charged pigment particles.

In one example, each of the plurality of first type of electrically charged pigment particles may comprise a light absorbing pigment and each of the plurality of second type of electrically charged pigment particles may comprise a light reflective pigment. Each of the plurality of first type of electrically charged pigment particles may comprise a black pigment and each of the plurality of second type of electrically charged pigment particles may comprise a white pigment. The plurality of first type of electrically charged pigment particles may have an average particle size that is smaller than the average particle size of the plurality of second type of electrically charged pigment particles.

In an open optical state, the plurality of first type of electrically charged pigment particles may be arranged in a channel of a microcell with a horizontal distribution that is reduced across the x dimension of the exposed microcell bottom inside surface from the outer perimeter to the inner perimeter of the channel of the microcell, and the plurality of second type of electrically charged pigment particles may be arranged in the channel of the microcell with a horizontal distribution that is increased across the x dimension of the exposed microcell bottom inside surface from the outer perimeter to the inner perimeter of the channel of the microcell.

The content of the charge control agent in the electrophoretic medium of the variable light transmission device may be from 0.1 weight percent to 10 weight percent of charge control agent by weight of the electrophoretic medium. The molecular structure of the charge control agent may include a quaternary ammonium functional group and a non-polar tail. The non-polar liquid of the electrophoretic medium may comprise a material selected from the group consisting of an aliphatic hydrocarbon, a cycloaliphatic hydrocarbon, an aromatic hydrocarbon, a halogenated aliphatic hydrocarbon, a polydimethylsiloxane, or mixture thereof.

### BRIEF DESCRIPTION OF DRAWINGS

FIG. 1 is an illustration of a cylindrical particle in a liquid under the influence of an applied electric field and resulting forces on the particle.

FIGS. 2A, 2B, 2C and 2D represent a side view of an example of a portion of a variable light transmission device of the present invention.

FIG. 3 illustrates a side view of a microcell in the open optical state and a side view of a microcell in the closed optical state. The electrophoretic medium comprises a plurality of one type of electrically charged pigment particles.

FIG. 4A is an example of a first embodiment of the present invention; this example is a DC-imbalanced waveform that can be applied on a variable light transmittance device to achieve a closed optical state; the waveform includes an AC waveform having a duty cycle that is higher than 50%.

FIG. 4B is an example of a second embodiment of the present invention; this example is DC-imbalanced waveform that can be applied on a variable light transmittance device to achieve a closed optical state; the waveform is a superposition of a DC voltage component and an AC waveform.

FIG. 5 illustrates the force exerted by an electrically charged pigment particle on the surface of a conical protrusion of the variable light transmission device of the present invention.

FIG. 6 shows a comparison of Fraunhofer diffraction patterns formed by apertures of the following shapes: (a) triangular, (b) square), (c) pentagonal, and (d) hexagonal.

FIG. 7 shows a comparison of a Fraunhofer diffraction pattern formed by a circular aperture and a Fraunhofer diffraction pattern formed by a hexagonal aperture.

FIG. 8 shows a comparison of a Fraunhofer diffraction pattern formed by a circular aperture without serrations and a Fraunhofer diffraction pattern formed by a circular aperture having serrations.

FIG. 9a shows a top view image of a device having circular apertures (channels) without serrations.

FIG. 9b shows a top view image of a device having circular apertures (channels) with serrations.

FIG. 10 shows the effect of the aperture ratio of a 3×3 array of square apertures on the size of the Point Spread Function.

FIG. 11 illustrates an example of an open optical state of a variable light transmission device according to the first embodiment.

FIG. 12 illustrates a top view of a microcell of the first embodiment.

FIG. 13 illustrates an example of an open optical state of a variable light transmission device according to the second embodiment.

FIG. 14 illustrates a horizontal distribution of the open optical state of a variable light transmission device according to the second embodiment.

FIG. 15 illustrates an example of an open optical state of a variable light transmission device according to the third embodiment.

FIG. 16 shows a graph of transparency and a graph of optical density of a layer comprising a plurality of black particles as a function of the layer thickness.

FIG. 17 shows a graph of transparency and a graph of optical density of a layer comprising a plurality of white particles as a function of the layer thickness.

FIG. 18 shows a graph of transparency and a graph of optical density of a layer comprising a combination of a plurality of black pigment particles and a plurality of white pigment particles as a function of the layer thickness.

FIG. 19 shows a plan view of a microcell of the variable light transmission device that was used in Example 1.

FIG. 20 illustrates a cross sectional view of a microcell of the variable light transmission device that was used in the Example 1.

FIG. 21 provides micrographs of open and closed optical states of the variable light transmission device of Example 1, the optical states resulting from various waveforms.

### DETAILED DESCRIPTION OF THE INVENTION

“Outside surface of a variable light transmission device” is an outside surface of the device that is parallel to the first light transmissive electrode layer, referring to the main surfaces on the viewing sides of the variable light transmission device, not the smaller surface on the periphery of the device. A “first outside surface” of a variable light transmission device is an outside surface that is located on the side of the device that is near the first light transmissive electrode layer (and away from the second light transmissive electrode layer). “A second outside surface” of a variable light transmission device is an outside surface that is located on the side of the device that is near the second light transmissive electrode layer (and away from the second light transmissive electrode layer).

“A location of a variable light transmission device” is a point at the first outside surface or at the second outside surface of the device.

“Percent transparency of a variable light transmission device” (% T) at a location of the device is given by Equation 1. Thus, “percent transparency of a variable light transmission device” (% T) at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io) times 100; the location of the second outside surface is symmetrical to the location of the first outside surface with respect to a plane, the plane being at equal distance between the first light transmissive electrode layer and the second light transmissive electrode layer.

$$\% T = ( I / Io ) \times 100 \qquad ( Equation 1 )$$

Analogously, “transparency, or transmission, of a variable light transmission device” at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io).

“Optical Density” of a variable light transmission device” (OD) at a location of the device is given by Equation 2. Thus, “optical density percent of a variable light transmission device” (OD) at a location of the device is the logarithm of the ratio of the intensity of light that enters the device at a location at the first outside surface of the variable light transmission device (Io) to the intensity of light that is transmitted through the variable light transmission device and exiting from a location of the second outside surface of the variable light transmission device (I); the location of the second outside surface is symmetrical to the location of the first outside surface with respect to a plane, the plane being at equal distance between the first light transmissive electrode layer and the second light transmissive electrode layer.

$$OD = log ( Io / I ) \qquad ( Equation 2 )$$

“A location of a device being adjacent to a channel” means that, if a line is drawn from the location vertically to an outer surface of the device, the line will cross the channel of the microcell.

“Varied optical density of the variable light transmission device across the x dimension of an exposed microcell bottom inside surface of a microcell” in an open optical state (in which the plurality of electrically charged pigment particles are present inside the channel of the microcell) means that the transparency of the variable light transmission device at a first location of the device, the first location being adjacent to the channel of the microcell, is different from the transparency of at least a second location of the device, the at least second location being adjacent to the channel of the same microcell.

“Varied visible light spectrum of the variable light transmission device across the x dimension of an exposed microcell bottom inside surface of a microcell” in the open optical state (in which the plurality of electrically charged pigment particles are present inside the channel of the microcell) means that the visible light spectrum of the variable light transmission device at a first location of the device, the first location being adjacent to the channel of the microcell, is different from the visible light spectrum of at least a second location of the device, the at least second location being adjacent to the channel of the same microcell. “Different” in reference to a visible light spectrum at location L1 versus a visible light spectrum at location L2 means that the maximum wavelength of the visible light spectrum at location L1 is different than the maximum wavelength of the visible light spectrum at location L2.

The distance of a point from a plane is the shortest perpendicular distance from the point to the plane. The shortest distance from a point to a plane is the length of the perpendicular parallel to the normal vector dropped from the given point to the given plane.

The distance between two planes in a three-dimensional space is the shortest distance between the two planes. It is the shortest distance between any point on one plane and any point on the other plane.

“Average particle size of a plurality of a type of particles” is the average length of the largest dimension of the plurality of particles.

“Slope of a cone” is defined as the angle that has first arm and second arm, (a) the first arm of the angle passing through the apex of the cone and a point K on the circumference of the base of the cone, (b) the second arm of the angle connecting point K and the center of the base of the cone; the angle is less than 90 degrees. Analogously, if we assume that a frustum of cone F is a portion of a cone G, the “slope of the frustum of cone” F is the slope of cone G.

“Slope of a polygonal pyramid” is defined as the angle that has first arm and second arm, (a) the first arm of the angle being a line that passes through the apex and point L on an edge of the base, point L being a point that separates the edge of the base in two equal linear segments, (b) the second arm being a line that connects point L and the center (C) of the base of the polygonal pyramid, where C is the point that is the intersection of the base of the polygonal pyramid and a line that passes through the apex of the polygonal pyramid, the line being vertical to the plane of the base of the polygonal pyramid. Analogously, if we assume that a frustum of polygonal pyramid H is a portion of pyramid B, the “slope of the frustum of polygonal pyramid” H is the slope of polygonal pyramid B.

The term “electrically charged pigment particles” may refer to electrically charged pigment particles that do not have any polymeric material on the surface of the pigment particles. The term “electrically charged pigment particles” may also refer to pigment particles that have a polymeric material on the surface of the pigment particles.

Absorption spectrum of first type, or second type, of electrically charged pigment particles refers to the spectrum of a dispersion of the electrically charged pigment particles in the non-polar liquid of the electrophoretic medium.

A “microcell inside wall surface” is the surface of the microcell wall that is in contact with the electrophoretic medium of the microcell.

A “microcell wall upper surface” is the surface of the microcell wall that is in contact with the sealing layer of the microcell. In the case that there is a light blocking layer on the microcell wall upper surface, the light blocking layer is disposed between the microcell wall upper surface and the sealing layer.

The term “DC-balanced waveform” or “DC-balanced driving waveform” applied to a pixel is a driving waveform where the driving voltage applied to the pixel is substantially zero when integrated over the period of the application of the entire waveform. The DC balance can be achieved by having each stage of the waveform balanced, that is, a first positive voltage will be chosen such that integrating over the subsequent negative voltage results in zero or substantially zero. If the waveform is not DC-balanced, it is referred to as “DC-imbalanced waveform” or “DC-imbalanced driving waveform.” The driving waveform applied to a pixel may have a DC-imbalanced portion and at least one additional pulse of the opposite impulse to ensure that the overall waveform applied to a pixel is DC-balanced. This additional pulse may be applied before the DC-imbalanced portion of the waveform (pre-pulse). Typical examples of DC-imbalanced waveforms include (a) a square or sinusoidal AC waveform having a duty cycle of less (or more) than 50%, and (b) square or sinusoidal AC waveform that has a DC offset.

The term “impulse” is the integral of voltage with respect to time. That is, for a waveform pulse having a voltage V applied for time t, the impulse is V x t. The impulse can be positive, if the polarity of voltage V is positive, or negative, if the polarity of voltage V is negative.

The term “net positive impulse” of a waveform means that negatively electrically charged pigment particles will be attracted to and will move towards the first light transmissive electrode layer during the application of the waveform.

The term “the velocity having a lateral component” in relation to the movement of a plurality of electrically charged pigment particles in a microcell of the variable light transmission device of the present invention is the average particle velocity in the horizontal direction of the plurality of electrically charged pigment particles. For this definition, we assume that the velocity of an electrically charged pigment particle is a vector resulting from the vector addition of the velocity in the horizontal direction (Vh), and the velocity in the vertical direction (Vv), and that the vertical direction in the case of the movement of the plurality of electrically charged pigment particles inside an electrophoretic microcell is the direction from the first light transmissive electrode layer to the second light transmissive electrode layer or form the second light transmissive electrode layer to the first light transmissive electrode layer. In the same system, the horizontal direction of the movement of the electrically charged pigment particles inside an electrophoretic microcell is the direction from one side of the microcell wall to the other side of the microcell wall, this direction being parallel to the first light transmissive electrode layer. Thus, the statement “the velocity having a lateral component” in relation to the velocity of a plurality of electrically charged pigment particles means that the magnitude of the average velocity of the plurality of electrically charged pigment particles in the horizontal direction is larger than zero.

“Vertical plane” of a channel of a microcell is defined herein as a plane that is vertical to the plane of the exposed microcell bottom inside surface of the microcell, the plane containing points P and Q, wherein P is a point on an outside base perimeter of the channel of the microcell, and Q is a point on an inside perimeter of the channel of the same microcell. As shown in FIG. 12. Points P and Q define a line segment PQ that corresponds to the shortest distance between the outer perimeter and the inner perimeter of the channel (FIG. 12). The linear segment PQ is part of the line of the x dimension of the exposed microcell bottom inside surface.

As defined above, the channel is a volume confined between the exposed microcell bottom inside surface, the protrusion surface, the microcell inside wall surface, and the midplane. In an open optical state of a microcell, the plurality of the electrically charged pigment particles may be present in the channel in a specific arrangement. The vertical plane of the channel may be perceived to consist of a set of parallel lines, each line of the set of parallel lines passing through a point of line segment PQ, each line of the set of parallel lines being vertical to the microcell bottom inside surface (or each line of the set of parallel lines being vertical to the midplane). Each line in the set of parallel lines intersects a number of electrically charged pigment particles that are arranged inside the channel. For example, the line of the set of parallel lines that passes from point P intersects a number of electrically charged pigment particles (Cp) that are arranged inside the channel, and the line of the set of parallel lines that passes from point P intersects a number of electrically charged pigment particles (Cq). In general, any line of the set of parallel lines that passes from a point of linear segment PQ, between the points P and Q intersects a number of electrically charged pigment particles (Ci) that are arranged inside the channel. The set of the numbers of the intersected electrically charged pigment particles (Cp, Ci, and Cq) of all the lines in the set of parallel lines that pass through point P to the parallel line that passes through point Q represent the horizontal distribution of the electrically charged pigment particles in the channel of the microcell.

“Horizontal distribution is reduced across the x dimension of the exposed microcell bottom inside surface from the outer perimeter of the channel of the microcell to the inner perimeter of the channel of the microcell” in reference to the arrangement of electrically charged pigment particles in the channel means that the number of intersected electrically charged pigment particles Cp is larger than the number of intersected electrically charged pigment particles Cq. Analogously, “horizontal distribution is increased across the x dimension of the exposed microcell bottom inside surface from the outer perimeter of the channel of the microcell to the inner perimeter of the channel of the microcell” in reference to the arrangement of electrically charged pigment particles in the channel means that the number of intersected electrically charged pigment particles Cp is smaller than the number of intersected electrically charged pigment particles Cq.

“Horizontal distribution is gradually reduced across the x dimension of the exposed microcell bottom inside surface from the outer perimeter of the channel of the microcell to the inner perimeter of the channel of the microcell” in reference to the arrangement of electrically charged pigment particles in the channel means that the number of intersected electrically charged pigment particles Cp is larger than the number of intersected electrically charged pigment particles Cq and the number of intersected electrically charged pigment particles Ci is monotonically reduced from the value of Cp to the value of Cq.

“A frustum” is the base portion of a cone or polygonal pyramid obtained by cutting the apex portion with a plane parallel to the base. It is also called a flat-top cone or pyramid because it does not have an apex but has two parallel bases.

The protrusion surface is defined as a surface of the protrusion structure of a microcell that is in contact with the electrophoretic medium not including the protrusion apex. For this definition, it is assumed that the entire available volume of the microcell is filled with the electrophoretic medium.

The microcell inside wall surface is defined as a surface of the microcell walls of a microcell that is in contact with the electrophoretic medium. For this definition, it is assumed that the entire available volume of the microcell is filled with the electrophoretic medium.

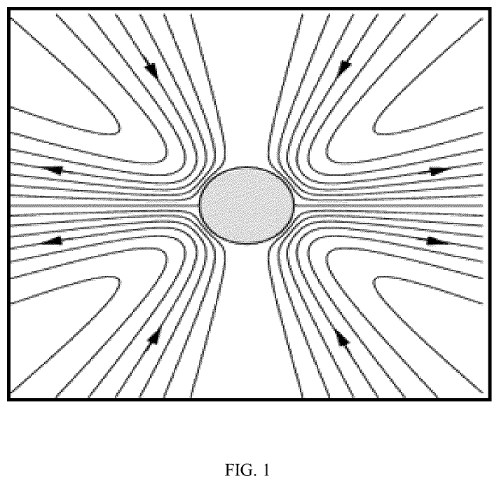

The phenomenon of Induced-Charge-Electro-Osmosis (ICEO) can be utilized to move polarizable particles, such as pigment particles, which are present in an electrophoretic medium, laterally. That is, the polarizable particles can move parallel to the electrode layers that sandwich the electrophoretic medium. In the presence of an electric field, a particle may experience a force, which is caused by polarization of the particle (or by polarization of an adsorbed conductive coating on the particle surface, or of the electrical double layer around the particle). This force may result in a perturbation in the flow of mobile charge, such as ions or charged micelles, in the electrophoretic medium, as shown in FIG. 1 for a cylindrical particle 101 surrounded by the liquid of the electrophoretic medium in the applied electric field. This figure is reproduced by the article of Bazant and Squires, J. Fluid Mech., 2004, 509, 217-252.

A perfectly symmetrical, spherical particle would experience no net force, but less symmetrical particles would experience forces having a component perpendicular to the direction of the applied field. The cooperative flows, which are created by a swarm of particles each experiencing such forces, can lead to “swirling” of an electrophoretic medium containing multiple particles. The maximum velocity u of this swirling for a particular particle, according to the theory advanced in the article by Bazant and Squires, would be given approximately by Expression 1.

$$u ∝ \frac{ε {RE}^{2}}{η ( 1 + {ω}^{2} {τ}^{2} )} \qquad ( Expression 1 )$$

In Expression 1, E is the field strength, ε is the dielectric constant of the solvent, η is the viscosity of the electrophoretic fluid, ω is the applied sinusoidal AC frequency, and τ is the time scale for building up a screening charge layer by motion of solvent-borne charges around charge. The time scale t is given by Equation 3.

$$ τ = \frac{{λ}_{D} R}{D} \qquad ( Equation 3 )$$

In Equation 3, λ_{D} is the Debye screening length, R is the particle radius, and D is the diffusion constant of charge carriers in the fluid.

According to Expression 1, as the frequency is raised, the value of ω²τ² increases, and the maximum velocity of induced-charge flows decreases. Furthermore, for values of ω²τ² that are significantly larger than 1, the maximum swirling velocity is proportional to the square of the ratio E/ω. Induced-charge flows occur in the same direction regardless of the polarity of the applied electric field and can thus be driven by alternating fields.

When the electrophoretic medium is contained within a microcell, as is preferred in electrophoretic displays, the geometries of the induced flows are affected by the shape of the particular microcell used. For example, in the simplest case of two parallel electrodes, it was shown that, using an appropriate electric field strength and AC frequency, the flow can adopt a roll structure with periodic spacing that corresponds to the width of the gap between the electrodes.

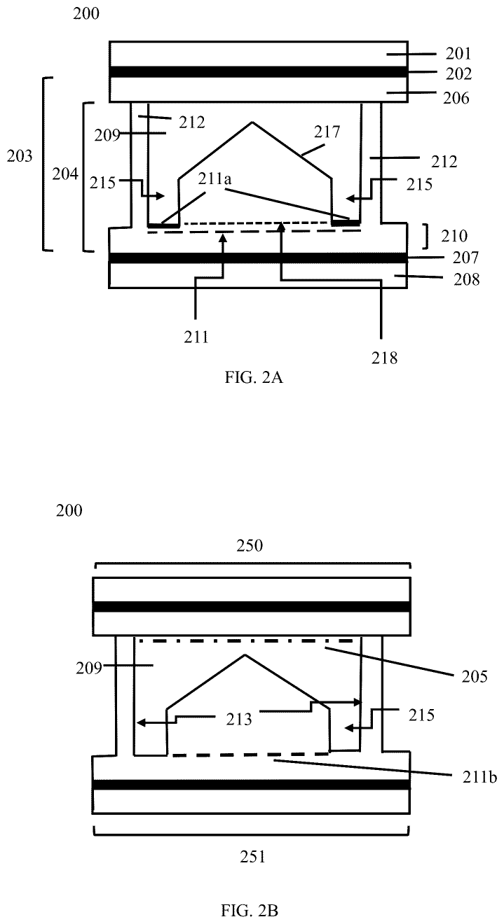

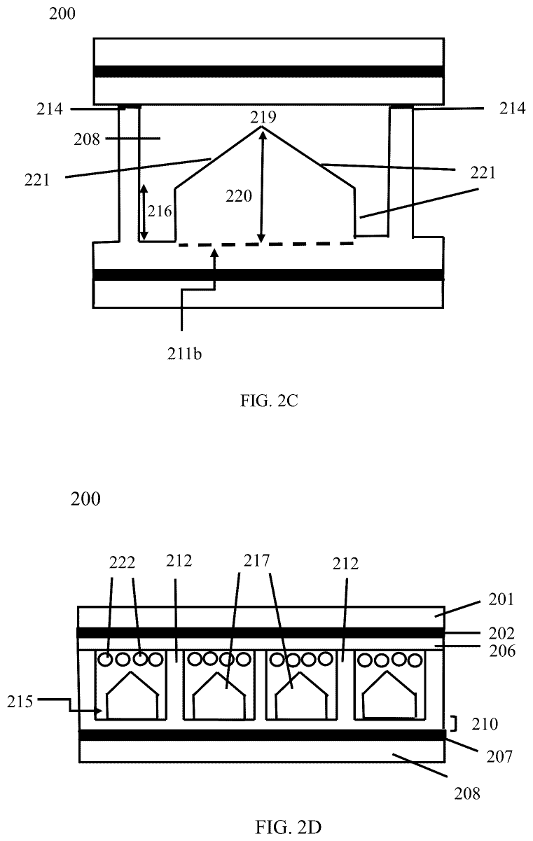

The inventors of the present invention used complex microcell structures that were formed by an embossing method to make variable light transmission devices. In one example, the embossed structure includes a conical protrusion on the bottom of each microcell. FIGS. 2A, 2B, and 2C illustrate an example of a variable light transmission device according to the present invention wherein the protrusion structure of the variable light transmission device is a cone on a cylinder. The cone of the protrusion structure can direct the electrophoretic flow of particles into a channel, as shown in FIGS. 2A, 2B, 2C. The electrically charged pigment particles would move towards the channel, if the electric field applied across the electrophoretic medium has the appropriate polarity in relation to the polarity of the electrically charged pigment particles. For example, the electrically charged pigment particles will move towards the channel, if the electrically charged pigment particles are positively charged and the applied voltage via the light transmissive electrodes results in negative polarity on the second light transmissive electrode. The same movement will take place if the electrically charged pigment particles are negatively charged and the applied voltage via the light transmissive electrodes results in positive polarity on the second light transmissive electrode. FIGS. 2A, 2B, and 2C illustrate a cross-section (not to scale) of a portion of a variable light transmission device that shows only one microcell of the plurality of microcells of the device. All three FIGS. 2A, 2B, and 2C are identical in terms of the device structure that is illustrated, but different parts of the device are identified on each of the figures.

The portion of the variable light transmission device 200 of FIGS. 2A, 2B, and 2C comprises a microcell layer comprising a plurality of microcells and a sealing layer. Although only one microcell is represented in FIGS. 2A, 2B, and 2C, one can envision the whole variable light transmission device that comprises the microcell layer comprising the plurality of microcells. The variable light transmission device may comprise first light transmissive substrate 201, first light transmissive electrode layer 202, a microcell layer 203 comprising a plurality or microcells 204 and a sealing layer 206, second light transmissive electrode layer 207, and second light transmissive substrate 208. Each microcell of the plurality of microcells 204 comprises an electrophoretic medium 209 including electrically charged pigment particles, a charge control agent, and a non-polar liquid. The components of the electrophoretic medium (electrically charged pigment particles, charge control agent, non-polar liquid) are not shown in FIGS. 2A, 2B, and 2C. Each microcell of the plurality of microcells 204 has a microcell opening 205, the sealing layer 206 spanning the microcell openings 205 of the plurality of microcells 204. Each microcell of the plurality of microcells 204 comprises microcell bottom layer 210, protrusion structure 217, microcell walls 212, and channel 215. Microcell bottom layer 210 has microcell bottom inside surface 211, the microcell bottom inside surface 211 that comprises exposed microcell bottom inside surface 211a and unexposed microcell bottom inside surface 211b. Unexposed microcell bottom surface 211b is in contact with the protrusion base 218.

In this example, the protrusion structure 217 is a cone on a cylinder. Protrusion structure 217 has a protrusion base 218, a protrusion surface 221, a protrusion apex 219, and a protrusion height 220. The protrusion apex 219 is a point or a set of points of the protrusion structure 217 having shorter distance from microcell opening 205 than all other points of the protrusion structure 217. In the example of the variable light transmission device of FIGS. 2A, 2B, and 2C, the protrusion apex 219 is the apex of the cone of the protrusion structure. The protrusion height 220 is the distance between the protrusion base 218 and the protrusion apex 219. If the protrusion structure 217 has a protrusion apex 219 that comprises more than one points, such as a planar surface, the protrusion height 220 is the distance between the planar surface and the protrusion base 218 of the protrusion structure 217. A microcell layer comprising a plurality of microcells 204 having a protrusion structure 217 may be manufactured by embossing thermoplastic or thermoset precursor layer using a pre-patterned male mold, followed by releasing the mold. The precursor layer may be hardened by radiation, cooling, solvent evaporation, or other means during or after the embossing step.

Microcell walls 212 have microcell inside wall surface 213 and a microcell wall upper surface 214. The microcell inside wall surface 213 is in contact with electrophoretic medium 209. The microcell wall upper surface 214 is the surface of microcell walls 212 of a microcell that is in contact with sealing layer 206. Furthermore, FIG. 2B shows first outside surface 250 being located on a side of the variable light transmission device that is near the first light transmissive electrode layer (202), and second outside surface (251) being located on a side of the variable light transmission device that is near the second light transmissive electrode layer (207).

Channel 215 is the volume between exposed microcell bottom inside surface 211a, microcell inside wall surface 213, and protrusion surface 221. Channel 215 is the volume location where most of the plurality of electrically-charge particles are present in the open optical state of the device. Channel 215 has channel height 216, that is half of the protrusion height 220. Thus, the channel height further defines the channel, along with exposed microcell bottom inside surface 211a, microcell inside wall surface 213, and protrusion surface 221.

FIG. 2D illustrates an example of a variable light transmission device according to the present invention wherein the protrusion structure of the variable light transmission device is a cone on a cylinder. The variable light transmission device of FIG. 2D is similar to that illustrated by FIGS. 2A, 2B, 2C, but shows a larger portion of the device that includes four microcells. Variable light transmission device 200 comprises first light transmissive substrate 201, first light-transmissive electrode layer 202, a microcell layer 203 comprising a plurality or microcells 204 and a sealing layer 206, second light transmissive electrode layer 207, and second light transmissive substrate 208. Each microcell of the plurality of microcells comprises an electrophoretic medium including a plurality of electrically charged pigment particles 222, a charge control agent, and a non-polar liquid. Each microcell of the plurality of microcells 204 has a microcell opening, the sealing layer 206 spanning the microcell openings of the plurality of microcells. Each microcell of the plurality of microcells comprises microcell bottom layer 210, protrusion structure 217, microcell walls 212, and channel 215. The variable light transmission device illustrated in FIG. 2D is in the closed optical state.

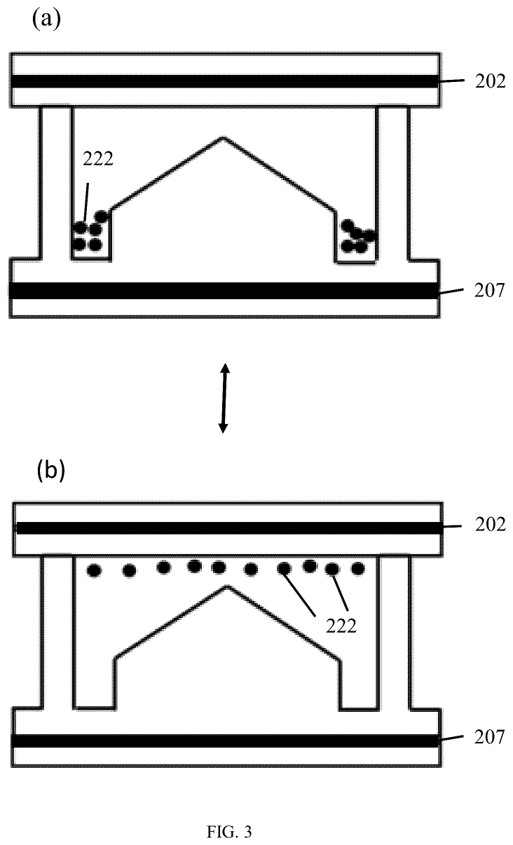

When a first electric field is applied between the first light transmissive electrode layer 202 and the second light transmissive electrode layer 207 via a first waveform, movement of the electrically charged pigment particles 222 towards the channel is caused when the polarity of the electrically charged pigment particles 222 and the voltage polarity of the second light transmissive electrode layer are opposite to each other. If the polarity of the electrically charged pigment particles 222 and the voltage polarity of the second light transmissive electrode layer are opposite to each other, the electrically charged pigment particles 222 will be attracted by the second light transmissive electrode, and the variable light transmission device will switch to an open optical state, the open optical state having higher percent transparency than the closed optical state. The open optical state is illustrated in FIG. 3a, where electrically charged pigment particles 222 are represented by black filled circles. In this example, the electrophoretic medium comprises one type of electrically charged pigment particles 222. In the open optical state, the electrically charged pigment particles 222 are present in the channel of the microcell. Thus, in the open optical state, light passing through the variable light transmission device from a location adjacent to the channel will be obstructed and the variable light transmission device will appear opaque adjacent to the channel, whereas the variable light transmission device will be transparent at other locations.

Application of a second electric field between the first light transmissive electrode layer 202 and the second light transmissive electrode layer 207 via a second waveform causes a movement of the electrically charged pigment particles 222 towards the first light transmissive electrode layer 202 with a velocity. This leads to the closed optical state, which is shown in FIG. 3b. The velocity has a lateral component. In the absence of a lateral component of the velocity, the closed optical state will be less effective, because the electrically charged pigment particles 222 will move from the channel of the open optical state towards the first light transmissive electrode layer 202, but these electrically charged pigment particles 222 will occupy an area near the perimeter of a microcell at the vicinity of the sealing layer 206. That is, electrically charged pigment particles 222 will not be spread all across the surface of the first light transmissive electrode layer 202. Thus, the closed optical state will not be effectively formed, because the closed optical state will have relatively high light transmittance.

The above indicates that it is somewhat easier to achieve a transition from the closed optical state to the open optical state, because the slope of the protrusion structure (for example, the cone of FIGS. 3a and 3b) will impart a lateral component to the velocity of the electrically charged pigment particles when they strike the protrusion surface of the protrusion structure during their movement towards second light transmissive electrode layer.

It is possible to shape the electric field within the variable light transmission device by making the electrical conductivities of the electrophoretic medium and the cone (protrusion structure) substantially different from each other. For example, if the cone is much less conductive than the electrophoretic medium, the field lines will tend to direct the electrically charged pigment particles into the channel. However, even in such a case it may still be necessary to provide a more substantial horizontal force component to redisperse the electrically charged pigment particles from the channel into the entire microcell volume. In addition, in the current state of the art it is easier to assemble and operate the device when the resistivities of the cone material and the electrophoretic medium are about equal, each being about 10¹⁰ Ω*cm, in which case the electric field lines will be oriented approximately vertically through the microcell. Thus, it would be preferred to use a waveform in which lateral motion is imparted to the electrically charged pigment particles.

The variable light transmission device may be switched to an open optical state by applying a first electric field between the first light transmissive electrode layer and the second light transmissive electrode layer via a first waveform to cause movement of the plurality of first type of electrically charged pigment particles towards the channel, resulting in the switching of the variable light transmission device to an open optical state, the plurality of first type of electrically charged pigment particles in the open optical state being located inside the channel. The variable light transmission device may be switched to a closed optical state by applying a second electric field between the first light transmissive electrode layer and the second light transmissive electrode layer via a second waveform to cause a movement of the plurality of first type of electrically charged pigment particles towards the first light transmissive electrode layer with a velocity, the velocity having a lateral component, and leading to a closed optical state, the second waveform comprising a series of at least two positive and negative pulses having a net positive or net negative impulse, wherein the closed optical state has lower percent transparency than the open optical state.

The second waveform may be DC-imbalanced. The second waveform may comprise at least one positive voltage and at least one negative voltage, the second waveform having a net positive or a net negative impulse. The choice of a net positive or net negative impulse depends on the polarity of the electrically charged pigment particles to be moved to the location of the electrophoretic medium near the sealing layer. Specifically, if the closed optical state involves movement of the plurality of first type of electrically charged pigment particles that are negatively charged, a net positive impulse is required to move those particles from the channel towards the first light transmissive electrode layer. In other words, this movement requires that the net result of the applied voltage be an attraction of the negatively charged particles by a positive voltage of the first light transmissive electrode layer in relation to the second light transmissive electrode layer. On the contrary, if the closed optical state involves movement of the plurality of first type of electrically charged pigment particles that are positively, a net negative impulse is required to move the electrically charged pigment particles from the channel near the second light transmissive electrode layer 207 towards the first light transmissive electrode layer.

A second electric field that is applied between the two light transmissive electrode layers via a second waveform achieves a closed optical state.

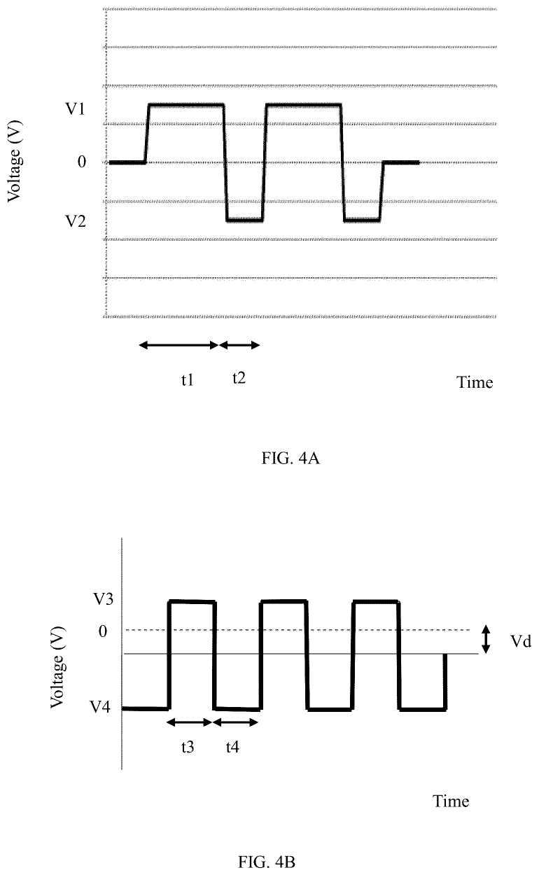

The second waveform may comprise an AC waveform, having a duty cycle different from 50%. An example of the second waveform is illustrated in FIG. 4A.

The AC waveform may have a positive or negative DC bias. DC bias may be achieved by controlling the duty cycle of the waveform. The duty cycle for a positively DC biased waveform is higher than 50%. The duty cycle of a positively DC biased waveform may be higher than 55%, higher than 60%, or higher than 65%. The duty cycle for a positively DC biased waveform may be from 55% to 95%, from 58% to 90%, from 60% to 88%, from 65% to 85%, or from 70% to 80%. Analogously, the duty cycle for a negatively DC biased waveform is lower than 50%. The duty cycle for a negatively DC biased waveform may be lower than 45%, lower than 40%, or lower than 35%. The duty cycle for a negatively DC biased waveform may be from 5% to 45%, from 8% to 40%, from 10% to 38%, from 15% to 35%, or from 20% to 30%.

The waveform illustrated in the example of FIG. 4A comprises an AC square waveform having two or more cycles. Each cycle may comprise a first pulse of amplitude V1 applied for time period t1 and a second pulse of amplitude V2 applied for time period t2, wherein V1 is positive and V2 is negative, and wherein t1 is larger than t2. In the case that the amplitude of V1 is equal to the amplitude of V2 (|V1|=|V2]), a DC bias is achieved by the difference in the time periods. In the case of the example of FIG. 4A, there is a positive DC bias, because the positive voltage V1 is applied for a longer time period (t1) than that of the negative voltage V2 (t2). Positive DC bias means that, if the electrically charged pigment particles of the variable light transmission device are negatively charged, the electrically charged pigment particles will move towards the first light transmissive electrode layer of the device. The duty cycle of the waveform can be calculated by Equation 4.

$$Duty Cycle = 100 \times ( V 1 \cdot t 1 ) / [ ( V 1 \cdot t 2 ) + ( V 2 \cdot t 2 ) ] \qquad Equation 4$$

In the waveform example of FIG. 4A, the amplitude of V1 can be equal to the amplitude V2 (|V1|=|V2|), but, in general, the amplitudes V1 and V2 may be different from each other.

The example of the driving waveform of FIG. 4A is DC-imbalanced. However, one or more additional pulses may be included in the waveform of FIG. 4A of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 4A is a square AC waveform. Other examples of AC waveforms that can be used include sinusoidal waveforms, trigonal waveforms, and sawtooth waveforms.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

The second waveform may comprise a waveform that is formed by a superposition of a DC voltage component and an AC waveform. An example of the second waveform is illustrated in FIG. 4B.

The waveform of FIG. 4B has a net negative impulse because of a DC offset (Vd). Although the period of time (t3) of the application of positive pulse is equal to the period of time (t4) of the application of negative pulse, a DC bias is achieved by the difference in the amplitudes of the pulses. Specifically, amplitude V3 of the positive pulse is smaller than amplitude V4 of the negative pulse. This is caused by the DC voltage component Vd of the waveform. That is, the waveform illustrated in FIG. 4B has a DC offset.

The example of the driving waveform of FIG. 4B is DC-imbalanced. However, one or more additional pulses may be included in the waveform of FIG. 4B of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 4B is a square AC waveform. Other examples of AC waveforms that may be used include a sinusoidal waveform, a trigonal waveform, and a sawtooth waveform.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

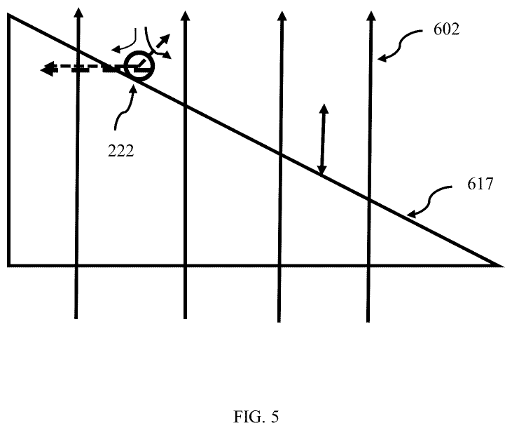

In a case of the ICEO-induced motion of the electrically charged pigment particles being relatively low, the protrusion structure of the microcell contributes to an effective operation of the variable light transmission device, even if the device is driven using a DC-balanced AC waveform. In the example of the protrusion structure being a cone, any electrically charged pigment particles that are located at the surface of the cone will experience a net force that will move them towards the apex of the cone, as shown in FIG. 5. FIG. 5 shows electrically charged pigment particle 222 in contact with protrusion structure 617 (cone) in an electric field 602. In this case, the ICEO flows are illustrated by the curved arrows, being more constrained on the “uphill” side of the cone than the “downhill” side. This imparts a force to the particle shown by the dotted horizontal arrow. There will be an opposing force perpendicular to the cone, forcing the particle towards the apex of the conc. With an appropriate choice of AC fields and frequencies, the particles can be moved out of the channel region and up the sides of the cone in this way.

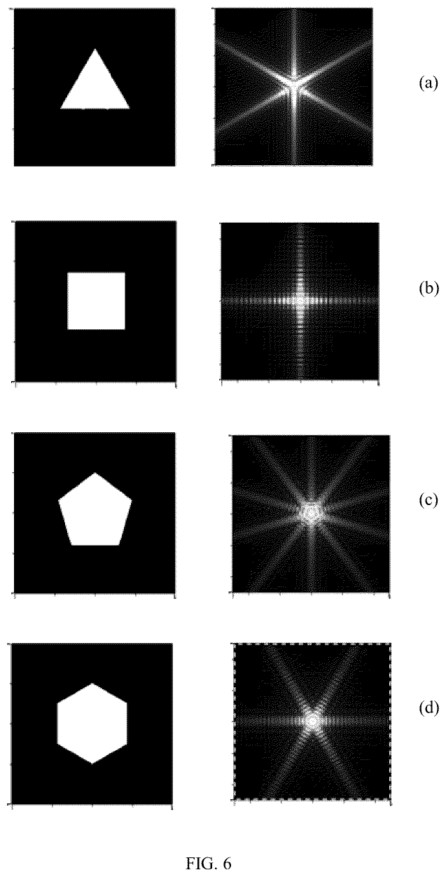

One problem encountered in open optical states of variable light transmission devices, where light-absorbing electrically charged pigment particles are located in the channels of microcells, is diffraction patterns that are observable within the field of vision. Such diffraction patterns, known as Fraunhofer diffraction patterns, can be disturbing to a viewer and are formed when light from a small object such as a light source in a dark ambient environment or when light from specular reflections of the sun in a bright ambient environment passes through the variable light transmission device in the open optical state. The cause the diffraction patterns is the existence of straight edges with sharp transition from light absorbing to light transmitting area in the channels of microcells. Such straight edges are formed by the arrangement of the absorbing particles in the channels of microcells. It is well known that the resulting diffraction pattern is directly related to the shape of the transparent shape of the microcell in the open optical state (aperture). FIG. 6 shows various Fraunhofer diffraction patterns (right side of FIG. 6), which are formed by various aperture shapes, which are shown on the left side of FIG. 6. Specifically, a triangle aperture forms the diffraction pattern shown in FIG. 6a, a square aperture forms the diffraction pattern shown in FIG. 6b, a pentagon aperture forms the diffraction pattern shown in FIG. 6c, and a hexagon aperture forms the diffraction pattern shown in FIG. 6d. In all of these examples, the resulting diffraction patterns include highly visible linear components. Thus, there are six linear components in the diffraction pattern shown in FIG. 6a, four linear components in the diffraction pattern shown in FIG. 6b, ten linear components in the diffraction pattern shown in FIG. 6c, and six linear components in the diffraction pattern shown in FIG. 6d.

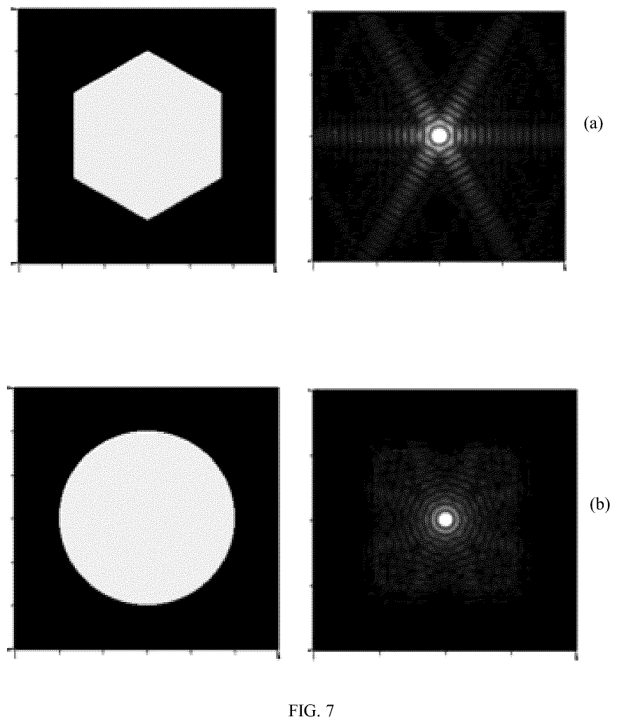

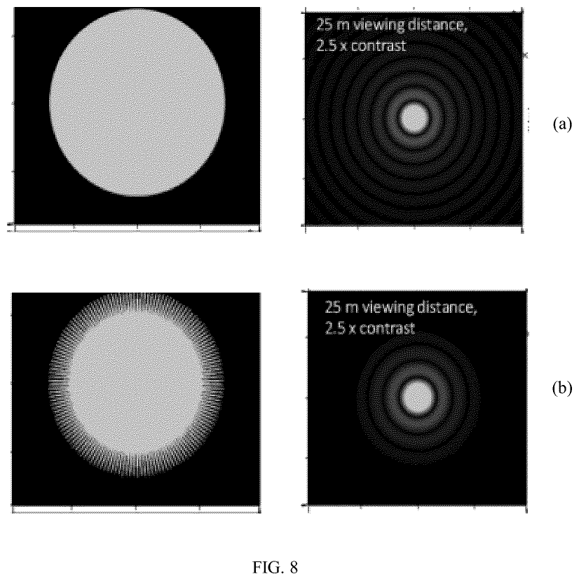

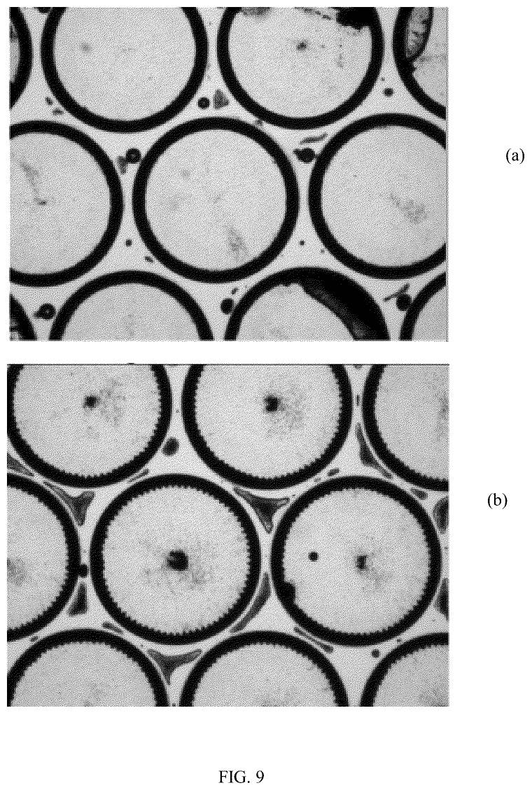

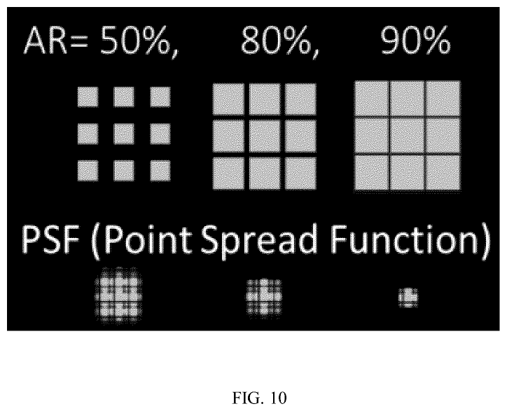

Several ways were found to mitigate diffraction patterns with highly visible linear features. Firstly, the use of a circular aperture forms a diffraction pattern where the intensity of diffraction is uniformly distributed over all diffraction angles. Thus, in the case of circular aperture, the highly visible linear diffraction patterns (shown in FIG. 6a-6d) are transformed to less visible diffraction rings of lower intensity, as shown in FIG. 7(b). In FIG. 7a, the diffraction pattern formed by a hexagon aperture is shown (same pattern shown in FIG. 6d) in comparison with the pattern formed by the circular aperture shown in FIG. 7b. FIG. 7b shows a diffraction pattern that includes concentric rings with decreasing light intensity as the diameter of the ring increases. Secondly, it was previously suggested (U.S. Patent Application with Publication No. 2023/0100320A1) to use apodization to mitigate highly visible linear diffraction patterns by softening the sharp transition from light absorbing to light transmitting area by replacing the straight edges of hexagonal and circular apertures with irregular or regular shapes. Regular shapes, including those described by sine wave and triangular zigzag or saw tooth functions, are referred to as serrations. However, theoretical calculations showed that the use of serrations in circular apertures provides only limited dampening of diffraction rings. The results of the calculations are shown in FIG. 8, which compares the diffraction pattern of a non-serrated circular aperture (FIG. 8a) with those of a serrated circular aperture (FIG. 8b). For the calculations, the diameter of the aperture was set to 275 micrometers, and the viewing distance was set to 25 m. In order to improve visibility of the diffraction pattern in print, the contrast was enhanced by a factor of 2.5. Furthermore, experiments with serrated circular apertures showed additional high-frequency chromatic diffraction patterns that were absent from the non-serrated circular apertures. Furthermore, it was observed that, when electrically charged pigment particles that absorb light are used in a variable light transmission device having a channel with serrated edges, the particles penetrated into the serration at the open optical state. Thus, the serrations were obscured by the particles, reducing the mitigation of the diffraction patterns. This phenomenon is shown in FIGS. 9a and 9b. Specifically, FIG. 9a shows a top view image of a device having circular apertures (channels) without serrations and FIG. 9b shows a top view image of a device having circular apertures (channels) with serrations. In general, circular apertures have the disadvantage of a small aperture ratio, which is the ratio of open area (transparent area) to total area of the electro-optic material layer, because the interstitial spaces between the apertures are larger. It is well known that a small aperture ratio is not desirable because it results in increased Point Spread Function (PSF) and in increased blurring effect caused by array diffraction. FIG. 10 shows the effect of the aperture ratio of a of a 3×3 array of square apertures in the size of Point Spread Function.

The inventors of the present invention discovered that the undesirable diffraction pattern observed at the open optical state can be mitigated using a variable light transmissive device having a microcell layer comprising a plurality of microcell, each microcell including an electrophoretic medium, each microcell having a channel (without serrations). That is, the mitigation of the undesirable diffraction pattern does not depend on serrations, but on a gradual transition of the optical density or the visible light spectral at the channel. The gradual transition of optical density can be achieved by a specific architecture of the microcell or by an appropriate arrangement of the electrically charged pigment particles in the channel. The transition of the visible light spectrum at the channel can be achieved by using a specific arrangement of at least two types of electrically charged pigment particles in the channel, wherein the two different types of electrically charged pigment particles have different visible light spectra.

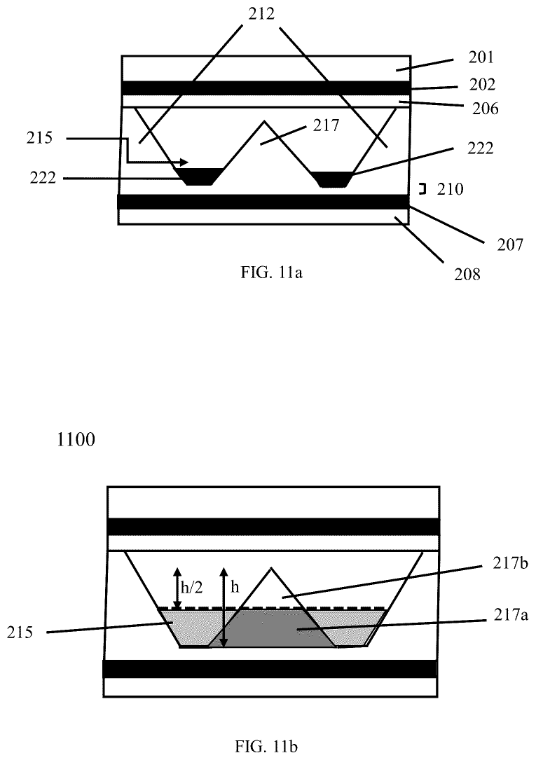

In a first embodiment, the electrically charged pigment particles of the electrophoretic medium of the variable light transmission device are light absorbing, the angle between the microcell inside wall surface and the microcell bottom inside surface is larger than 90 degrees, and the combination of the channel and the lower part of the protrusion structure is a geometric solid selected from the group consisting of (a) a cylinder, (b) a cone, (c) a polygonal pyramid having a polygon base, the polygon base having from 3 to 20 sides, (d) a polygonal prism, the polygonal prism having two polygon bases, the polygon bases having from 3 to 20 sides, (e) a frustum of cone, and (f) a frustum of polygonal pyramid, the frustum of polygonal pyramid having a first and a second bases, the first and second bases being polygons having from 3 to 20 sides. An example of a variable light transmission device of the first embodiment of a variable light transmission device is illustrated in FIGS. 11a and 11b. In fact, FIG. 11a illustrates a side view of only one microcell of the device in an open optical state. The variable light transmission device 1100 of FIG. 11a comprises a first light transmissive substrate 201, first light transmissive electrode layer 202, a microcell layer 203 comprising a plurality or microcells 204 and a sealing layer 206, second light transmissive electrode layer 207, and second light transmissive substrate 208.

Each microcell of the plurality of microcells comprises an electrophoretic medium including light absorbing electrically charged pigment particles 222, a charge control agent, and a non-polar liquid. Each microcell of the plurality of microcells has a microcell opening, the sealing layer 206 spanning the microcell opening of the plurality of microcells. Each microcell of the plurality of microcells comprises microcell bottom layer 210, protrusion structure 217, microcell walls 212, and channel 215. Microcell bottom layer 210 has microcell bottom inside surface, the microcell bottom inside surface that comprises exposed microcell bottom inside surface and unexposed microcell bottom inside surface. Unexposed microcell bottom surface is in contact with the protrusion base. The protrusion of the device example of the device illustrated in FIG. 11a is a cone.

FIG. 11b illustrates a side view of a microcell of variable light transmission device 1100, labeling different structural elements of the device than the elements labeled in FIG. 11a. Specifically, FIG. 11b shows the protrusion structure (cone) of the device, which comprises a lower part 217a (dark gray) and an upper part (217b). FIG. 11b also shows channel 215 (light gray). The protrusion structure of the microcell of variable light transmission device 1100 has height h. As defined previously, the lower part of the protrusion structure is a geometric solid defined by the protrusion base, the protrusion surface, and the midplane, wherein the distance between the midplane and the protrusion base is equal to the half of protrusion height. In the device example of FIG. 11b, the combination of channel 215 and lower part of protrusion structure is a frustum of cone having two circular bases, a first base and a second base. The distance between the two bases is equal to half the height (h/2) of the protrusion structure h.

The first base of the frustum of cone has a larger area than the second base. The second base can also be called the apex of the geometric solid according to the apex definition (for the protrusion structure), which was provided above. The second base of the frustum of cone in this example is in contact with the microcell bottom inside surface of the microcell, whereas the first base is included in the midplane. Other examples of devices may have different geometric solids for the combination of the channel and lower part of protrusion structure of microcell. The geometric solid for the combination may be selected from the group consisting of (a) a cylinder, (b) a cone, (c) a polygonal pyramid having a polygon base, the polygon base having from 3 to 20 sides, (d) a polygonal prism, the polygonal prism having two polygon bases, the polygon bases having from 3 to 20 sides, (e) a frustum of cone, and (f) a frustum of polygonal pyramid, the frustum of polygonal pyramid having a first and a second bases, the first and second bases being polygons having from 3 to 20 sides.

An illustration of a top view of a microcell of the first embodiment is shown in FIG. 12. The two concentric circles correspond to the channel of the microcell. FIG. 12 shows a line segment PQ which corresponds to the shortest distance between a point P on the outer perimeter of the channel of the microcell and the inner perimeter of the channel of the microcell. The PQ line segment is included in a line of the x dimension of the exposed microcell bottom inside surface. The location of the point P on the outer perimeter of the channel of the microcell is not important to the definition of a x dimension, because of the symmetrical nature of the exposed microcell bottom inside surface. The y dimension of the exposed microcell bottom inside surface is orthogonal to the x dimension and both lines that correspond to the x dimension and the y dimension are on the plane of the exposed microcell bottom inside. The z dimension is provided by a line that is orthogonal to the x dimension and the y dimension of the exposed microcell bottom inside, as shown in FIG. 12.

The architecture of the variable light transmission device of the first embodiment and more specifically the architecture of the channel enables mitigation of the diffraction pattern because, in the open optical state, the thickness of the volume occupied by the electrically charged pigment particles in the channel varies. This means that the optical density of the variable light transmission device varies across the x dimension of the exposed microcell bottom inside surface of the microcell. Thus, there is a gradient transition from light absorbing to light transmitting area in the channels of microcells.

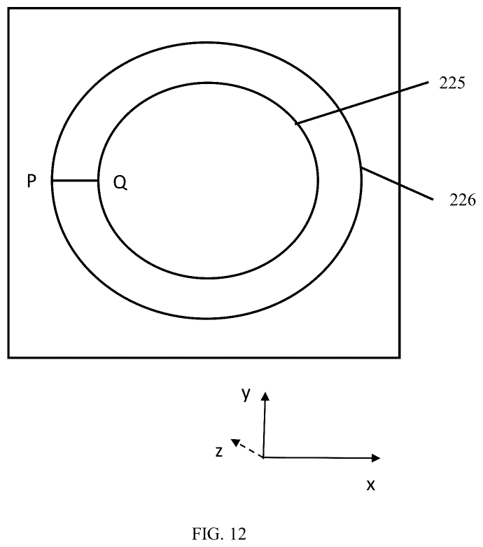

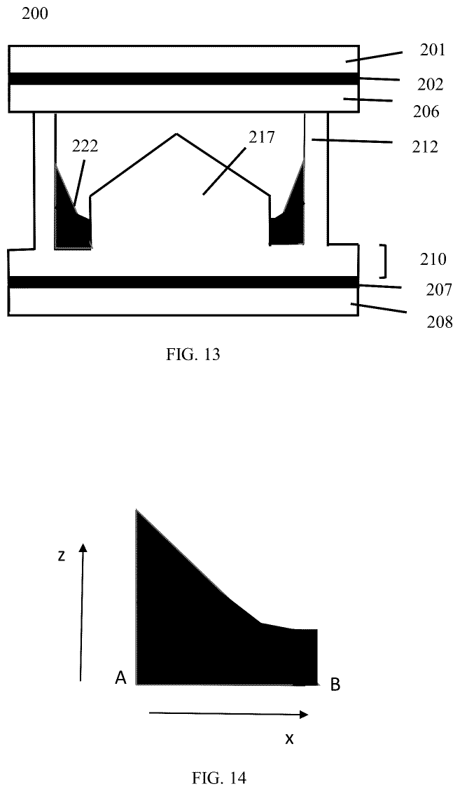

In a second embodiment, the open optical state of a variable light transmission device is illustrated in FIG. 13. The variable light transmission device 200 comprises a first light transmissive electrode layer 201, a second light transmissive electrode layer 202, and a microcell layer. The microcell layer is disposed between the first light transmissive layer 202 and the second light transmissive layer 207. Upon application of an electric field between the first light transmissive electrode layer 202 and the second light transmissive electrode layer 207, the amount of light passing through the device can be modulated. The microcell layer comprises a plurality of microcells and a sealing layer 206. Each of the plurality of microcells includes an electrophoretic medium, the electrophoretic medium comprising light absorbing electrically charged pigment particles 222, a charge control agent, and a non-polar liquid. Each microcell of the plurality of microcells has a microcell opening. The sealing layer of the microcell layer spans the microcell opening of the plurality of microcells. Each microcell of the plurality of microcells comprises a microcell bottom layer 210, a protrusion structure 217, microcell walls 121, a midplane, and a channel. The microcell bottom layer 210 has a microcell bottom inside surface, the microcell bottom inside surface comprising an exposed microcell bottom inside surface and an unexposed microcell bottom inside surface. The protrusion structure 217 has a protrusion base, a protrusion surface, a protrusion apex, and a protrusion height. The protrusion structure 217 consists of an upper part and a lower part. The midplane is a plane that is parallel to the sealing layer, the midplane being located between the protrusion base and the protrusion apex, the distance between the midplane and the protrusion base being equal to half of the protrusion height. The midplane divides the protrusion structure (217) into the lower part and the upper part,

The protrusion apex is a point or a set of points of the protrusion structure, the point or the set of points having shorter distance from the microcell opening than all other points of the protrusion structure. The protrusion height is the distance between the protrusion base and the protrusion apex. The protrusion surface is the surface of the protrusion structure not including the protrusion apex that is in contact with the electrophoretic medium. The microcell walls have a microcell inside wall surface and a microcell wall upper surface. The microcell inside wall surface is the surface of the microcell walls of a microcell that is in contact with the electrophoretic medium. The microcell wall upper surface is the surface of the microcell walls of a microcell that is in contact with the sealing layer.

The protrusion structure 217 and the exposed microcell bottom inside surface 211a have an intersection. The microcell inside wall surface (213) and the exposed microcell bottom inside surface (211a) have an intersection.

The channel has a channel height, an inner perimeter, and an outer perimeter. The channel height is half of the protrusion height. The inner perimeter 225 of the channel is the intersection of the microcell wall inside wall surface 213 and the exposed microcell bottom inside surface 211a. The outer perimeter 226 is the intersection of the protrusion base 218 and the exposed microcell inside surface 211a. The unexposed microcell bottom inside surface 211b is a part of the microcell inside surface 211 that is in contact with the protrusion base 218.

The channel is a volume confined between the exposed microcell bottom inside surface 211a, the protrusion surface 221, the microcell inside wall surface 213, and the midplane.

The variable light transmission device has a first outside surface and a second outside surface. The first outside surface is located on a side of the variable light transmission device that is near the first light transmissive electrode layer; the second outside surface is located on a side of the variable light transmission device that is near the second light transmissive electrode layer.

The electrically charged pigment particles of a variable light transmission device of the second embodiment may be light absorbing. The electrically charged pigment particles in an open optical state may be arranged in a channel of a microcell with a horizontal distribution that is reduced across the x dimension of the exposed microcell bottom inside surface from the outer perimeter of the microcell to the inner perimeter of the microcell as shown in FIG. 13. The electrically charged pigment particles in an open optical state may be arranged in a channel of a microcell with a horizontal distribution that is gradually reduced from the outer perimeter of the microcell to the inner perimeter of the microcell. The arrangement of the electrically charged pigment particles in an open optical state may be achieved via the application of an electric field between the first light transmissive electrode layer and the second light transmissive electrode layer that causes a movement of the electrically charged pigment particles towards the second light transmissive electrode layer with a velocity, the velocity having a lateral component as described above.

In the open optical state of a microcell of the variable light transmission device of the second embodiment, the electrically charged pigment particles are arranged inside the channel so that the horizontal distribution is reduced across the x dimension of the exposed microcell bottom inside surface from the outer perimeter of the channel of the microcell to the inner perimeter of the channel of the microcell. The horizontal distribution may be gradually reduced across the x dimension of the exposed microcell bottom inside surface from the outer perimeter of the channel of the microcell to the inner perimeter of the channel of the microcell.

FIG. 14 illustrates the horizontal distribution of the open optical state of the variable light transmission device of FIG. 13. As shown in FIG. 14, the horizontal distribution is reduced across the x dimension of the exposed microcell bottom inside surface from the outer perimeter of the channel of the microcell to the inner perimeter of the channel of the microcell. The result of the reduced horizontal distribution across the x dimension of the exposed microcell bottom inside surface enables mitigation of the diffraction pattern because, in the open optical state, the optical density of the variable light transmission device is varied across the x dimension of the exposed microcell bottom inside surface of a microcell. Thus, there is a gradient transition from light absorbing to light transmitting area in the channels of microcells.

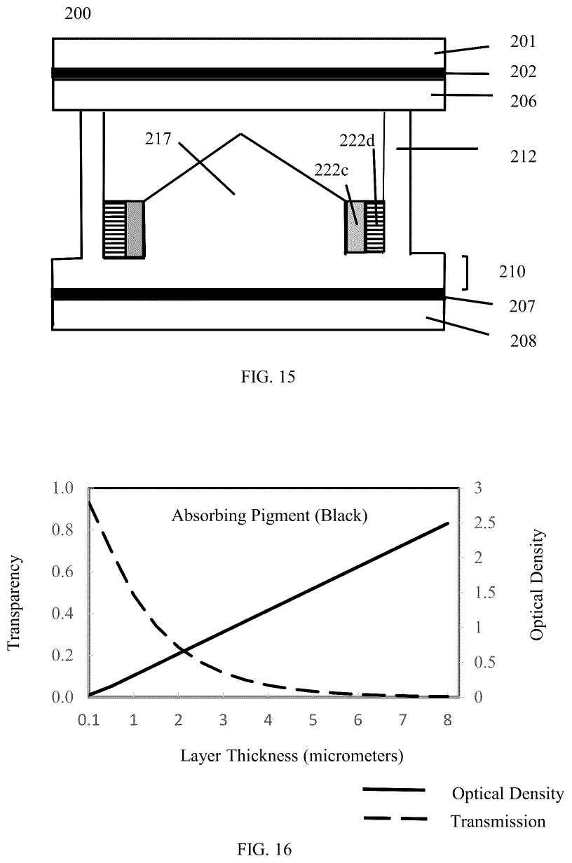

In a third embodiment, the open optical state of a variable light transmission device is illustrated in FIG. 15. The variable light transmission device 200 is similar to the device of the second embodiment. As with the variable light transmission device of the second embodiment, the electrophoretic medium comprises light absorbing electrically charged pigment particles. The electrophoretic medium comprises a plurality of first type of electrically charged pigment particles 222c and a plurality of second type of electrically charged pigment particles 222d. Each of the plurality of first and second types of electrically charged pigment particles (222c and 222d) may comprise a pigment, the pigment being light absorbing. The plurality of first type of electrically charged pigment particles 222c has a first absorption spectrum in visible light. The plurality of second type of electrically charged pigment particles 222d has a second absorption spectrum in visible light. The first absorption spectrum in visible light is different from the second absorption spectrum in visible light. Each of the plurality of first type of electrically charged pigment particles 222c may have the same charge polarity as the charge polarity of each of the plurality of second type of electrically charged pigment particles 222d. The first type of electrically charged pigment particles 222c may have different zeta potential from the zeta potential of the second type of electrically charged pigment particles 222d.

In an open optical state, the plurality of first type of electrically charged pigment particles may be arranged in a channel of a microcell with a horizontal distribution that is reduced across the x dimension of the exposed microcell bottom inside surface from the outer perimeter to the inner perimeter of the channel of the microcell, and the plurality of second type of electrically charged pigment particles may be arranged in the channel of the microcell with a horizontal distribution that is increased across the x dimension of the exposed microcell bottom inside surface from the outer perimeter to the inner perimeter of the channel of the microcell. This can be achieved via the application of an electric field between the first light transmissive electrode layer and the second light transmissive electrode layer that causes a movement of the electrically charged pigment particles towards the second light transmissive electrode layer with a velocity, the velocity having a lateral component as described above. Different shape, size, and/or zeta potential between the first and the second electrically charged pigment particles contribute to different lateral component of the velocities between the first and second electrically charged pigment particles, resulting in the arrangement of the plurality of first and second electrically charged pigment particles that was described above. FIG. 15 illustrates an example of a distribution of the plurality of first and second electrically charged pigment particles (222c and 222d) in the channel of a microcell. The distribution of FIG. 15 indicates that the two types of electrically charged pigment particles are fully separated into different volumes of the channel. This is not necessary and various parallel lines of the set of parallel lines of a vertical plane of the channel, as defined above, may intersect a combination of a number of first type of electrically charged pigment particles and a number of second type of electrically charged pigment particles. Furthermore, the electrophoretic medium may further comprise a plurality of third type of electrically charged pigment particles, having a spectrum in the visible light that is different from the spectrum of both the first and the second electrically charged pigment particles. Each of the plurality of third type of electrically charged pigment particles may have the same charge polarity as the charge polarity of the first and the second electrically charged pigment particles. The third type of electrically charged pigment particles may have zeta potential that is different from the zeta potential of the first and the second electrically charged pigment particles.

The result of the above horizontal distributions of the plurality of first and second electrically charged pigment particles across the x dimension of the exposed microcell bottom inside surface from the outer perimeter of the channel of the microcell to the inner perimeter of the channel of the microcell enables mitigation of the diffraction pattern because, in the open optical state, the spectrum in visible light is varied across the x dimension of the exposed microcell bottom inside surface of a microcell from the outer perimeter of the channel of the microcell to the inner perimeter of the channel of the microcell. Thus, there is a gradient transition from light absorbing to light transmitting area in the channels of microcells.

The first, second, and third embodiments of the variable light transmission device have a common element in their open optical state. That is, the device has a varied transmission (or optical density) or light spectrum across the x dimension of the exposed microcell bottom inside surface of a microcell.

The graph of FIG. 16 illustrates a decrease in transmittance and increase in optical density with layer thickness for an electrophoretic medium comprising black electrically charged pigment particles, the content of the black electrically charged pigment particles being 8 volume percent black electrically charged pigment particles by volume of the electrophoretic medium. In this example, the optical density increases linearly with thickness, which allows to apodize aperture boundaries and to mitigate potential diffraction patterns.

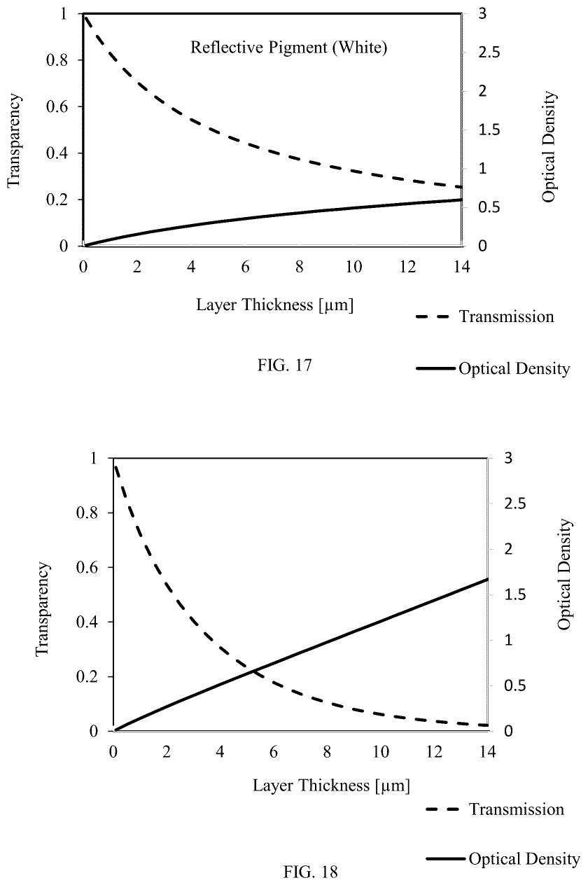

The graph of FIG. 17 illustrates the dependence of the nature of the electrically charged pigment particles in the electrophoretic medium. Specifically, FIG. 17 illustrates the transparency and optical density of a composition that comprises reflecting white pigments (instead of absorbing black pigments of the graph of FIG. 16). The concentration of the reflecting white pigment in the electrophoretic medium is 15 volume percent by volume of the electrophoretic medium. Here, although the reflecting white pigment effectively hides objects behind the variable light transmission device because of the increased reflection (lace-curtain effect), the optical density is limited. This makes the variable light transmission device ineffective in situations where the space behind the device is lit but the environment outside the device is dark. Thus, it would be beneficial for variable light transmission devices that are used for window application where the room behind the window is lit but the environment outside the window is dark, to have an electrophoretic medium comprising reflective white electrically charged pigment particles and a small amount of absorbing black electrically charged pigment particles (or other absorbing particles). In this case, the optical density and the privacy protection associated by increased optical density increases. The graph of FIG. 18 illustrates transparency and optical density of a composition that comprises reflecting white pigments and absorbing black pigments. The concentration of the white pigment in the electrophoretic medium is 15 volume percent by volume of the electrophoretic medium and the concentration of the black pigment in the electrophoretic medium is 1.5 volume percent by volume of the electrophoretic medium.

In all of the embodiments of the variable light transmission device, the electrophoretic medium comprises electrically charged pigment particles, a charge control agent and non-polar liquid. Charge control agents are typically oligomeric or polymer materials that are soluble in the non-polar liquid of the electrophoretic medium. Charge control agents are surfactant-type molecules having one or more polar functional groups (head) and a non-polar part (tail). The electrophoretic medium may comprise a charge control agent in a concentration of from 0.1 weight percent to 10 weight percent by weight of the electrophoretic medium. The electrophoretic medium may comprise a charge control agent in a concentration of from 0.5 weight percent to 9 weight percent, from 0.7 weight percent to 8 weight percent, from 1 weight percent to 7 weight percent, or from 1 weight percent to 6 weight percent by weight of the electrophoretic medium.

The non-polar liquid of the electrophoretic medium may comprise an aliphatic hydrocarbon, a cycloaliphatic hydrocarbon, an aromatic hydrocarbon, a halogenated aliphatic hydrocarbon, a polydimethylsiloxane, or mixture thereof. Typically, solvents used in electrophoretic media have low dielectric constant (preferably less than 10 and desirably less than 3), low viscosity, low vapor pressure, and relatively high refractive index. Examples of solvents include, but are not limited to, aliphatic hydrocarbons such as heptane, octane, and petroleum distillates such as Isopar® (Exxon Mobil) or Isane® (Total), terpenes, such as limonene, e.g., 1-limonene, and aromatic hydrocarbons, such as toluene. A particularly preferred solvent is limonene since it combines a low dielectric constant (2.3) with a relatively high refractive index (1.47). The refractive index of the electrophoretic medium may be modified with the addition of index matching agents. For example, the aforementioned U.S. Pat. No. 7,679,814 describes an electrophoretic medium suitable for use in a variable light transmission device in which the non-polar liquid of the electrophoretic medium comprises a mixture of a partially hydrogenated aromatic hydrocarbon and a terpene, a preferred mixture being d-limonene and a partially hydrogenated terphenyl, available commercially as Cargille® 5040 from Cargille-Sacher Laboratories, 55 Commerce Rd, Cedar Grove N.J. 07009. To reduce haze, it is preferred that the refractive index of the encapsulated electrophoretic medium closely matches that of the encapsulating material. In most instances, it is beneficial to use an electrophoretic medium having a refractive index between 1.51 and 1.57 at 550 nm, preferably about 1.54 at 550 nm.

The electrophoretic medium may also comprise a flocculating agent, also called depletor. The depletor induces an osmotic pressure difference between pigment-pigment particle and pigment particle depletor molecules. As a result, bistability of the optical states (open and closed) of the device is enhanced. Depletors are typically polymeric material such as polyisobutylene and polydimethylsiloxane.

### EXAMPLES

### Example 1

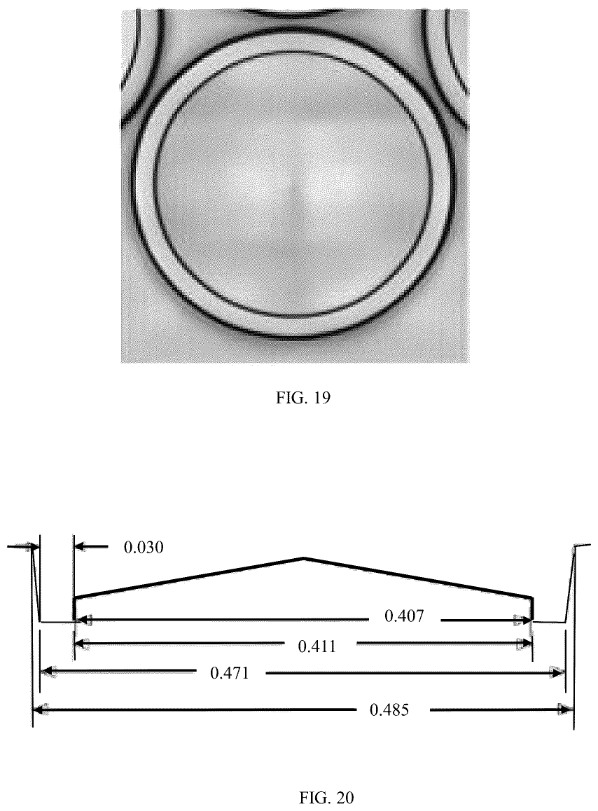

A device was prepared by laminating together a sheet of polyethylene terephthalate (PET) coated with an Indium Tin Oxide (ITO) transparent conductor to an embossed microcell array on a second sheet of PET/ITO containing and electrophoretic medium. The structure of the device corresponded to the illustration in FIG. 2A to 2D, except that the sealing layer 212 was not incorporated. The structure of the embossed microcell array is shown in FIG. 19, which is a plan view of a microcell of the device. FIG. 20 illustrates the corresponding cross-sectional view of one microcell of the device. Table 1 shows the dimensions of the microcell.

TABLE 1
Device Structure

| | Distance in |
|---|---|
| Element | micrometers |
| Cavity Pitch: Center-to-Center of microcells | 500 |
| Height of cylinder (base) under cone protrusion | 15.2 |
| Maximum height of particle fill level (above base) | 15.2 |
| Minimum wall width at first substrate | 15 |
| Draft angle for walls and cone base | 8 |
| Wall height | 50 |
| Wall recess/groove width at first substrate | 10 |
| Wall recess/groove draft angle | 26.6 |
| Wall recess/groove depth | 5 |
| Clearance between protrusion apex and top of wall | 9 |
| Cone slope in degrees | 7.3 |

The width of each microcell of the electro-optic device of the present invention may be from 300 to 700 micrometers, from 350 to 650 micrometers, or from 400 to 600 micrometers. The width of a microcell is defined as the length of the longest linear segment between any two points of the outer perimeter of the channel of the microcell. The height of each microcell of the electro-optic device of the present invention may be from 20 to 60 micrometers, from 25 to 55 micrometers, or from 30 to 50 micrometers. The height of a microcell is the distance between the plane of the microcell bottom inside surface and the plane of the bottom surface of the sealing layer, the bottom surface of the sealing layer being in contact with the electrophoretic medium, assuming that the entire available volume of the microcell is filled with the electrophoretic medium. The height of the protrusion structure of each microcell may be from 17 to 57 micrometers, from 20 to 55 micrometers, from 25 to 50 micrometers, from 30 to 40 micrometers, or from 35 to 45 micrometers. The length of the channel of each microcell of the electro-optic device of the present invention may be from 5 to 23 micrometers, from 7 to 20 micrometers, or from 10 to 18 micrometers. The length of the channel is the length of the line segment that corresponds to the shortest distance between the outer perimeter and the inner perheter of the channel; from example, the length of line segment PQ of the microcell that is illustrated in FIG. 12 is the length of the channel of the corresponding microcell. The thickness of each microcell wall may be from 1 to 30 micrometers, from: 2 to 27 micrometers, from 3 to 25 micrometers, from 4 to 20 micrometers, or from 5 to 15 micrometers. Thickness of a microcell wall is the average thickness of the wall of the microcell.

The electrophoretic medium comprised a white pigment, a hydrocarbon solvent, a charge control agent (CCA), and a depletor. The white pigment particles were prepared with a titanium dioxide pigment core and a polymer shell, as described in Example 1 of U.S. Pat. No. 8,582,196. In the example, the electrophoretic medium sample was prepared by mixing 10 weight percent of white pigment and 5 weight percent of a charge control agent (Cationic Charge Control Agent from Example 1—CCA111 of US2020/0355978) in Isopar E solvent. The device was switched from the open optical state to the closed optical state with a 50V square wave AC waveform with 50% duty cycle.

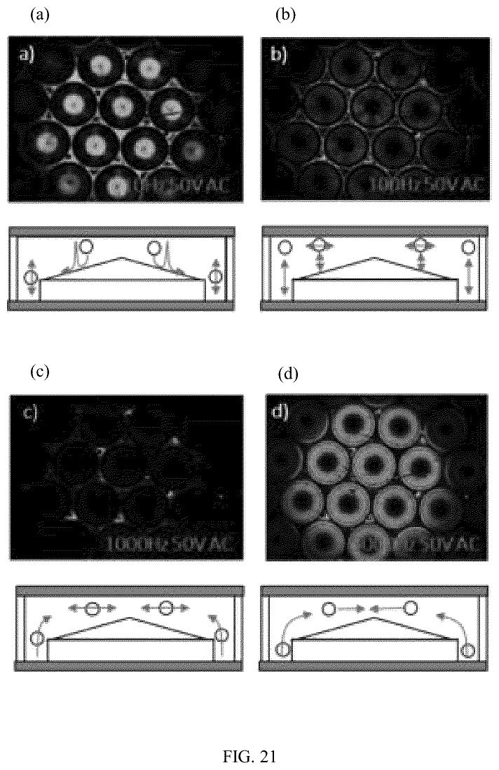

Different pigment motion styles were observed by increasing AC frequencies from 0 Hz to 5000 Hz as shown in FIG. 21. At the low frequency of 10 Hz, the white pigment moved towards the channel of the microcell (FIG. 21a), presumably by slight nudges down the slope of the cone. Once located in the channel, the pigment switched up and down in a vertical direction. At this low frequency of 10 Hz, the motion was dominated by normal electrophoresis. By increasing the frequency to 100 Hz, the pigment tended to spread laterally into the region above the cone in the embossed microcell structure (FIG. 21b). At frequency of 1000 Hz, the white pigments completely spread into the circles of the embossed microcell structure, as shown in FIG. 21c. In the frequency of 1000 Hz, it is thought that the pigment behavior was dominated by induced-charge lateral motion, possibly the result of ICEO. At frequency of 5000 Hz, the white pigment particles tended to center of the near cone region of embossed microcell structure, as shown in FIG. 21d.

Parts of the structures in the drawings: 200, 1100 Variable light transmission device; 201 First transparent substrate; 202 First light-transmissive electrode layer; 203 Microcell layer; 204 Plurality or microcells; 205 Microcell opening; 206 Sealing layer; 207 Second light-transmissive electrode layer; 208 Second transparent substrate; 209 Electrophoretic medium; 210 Microcell bottom layer; 211 Microcell bottom inside surface; 211a Exposed microcell bottom inside surface; 211b Unexposed microcell bottom inside surface; 212 Microcell walls; 213 Microcell inside wall surface; 214 Microcell wall upper surface; 125 Channel; 216 Channel height; 217 Protrusion structure; 217a Lower part of protrusion structure; 217b Upper part of protrusion structure; 218 Protrusion base; 219 Protrusion apex; 220 Protrusion height; 221 Protrusion surface; 222 Electrically charged pigment particles; 222a, 222c First type of electrically charged pigment particles; 222b, 222d Second type of electrically charged pigment particles; 225 Inner perimeter of channel; 226 Outer perimeter of channel; 250 First outside surface of variable light transmission device; 251 Second outside surface of variable light transmission device.

The invention claimed is:

1. A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206),
each microcell of the plurality of microcells (204) including an electrophoretic medium (209), the electrophoretic medium (209) comprising a plurality of first type of electrically charged pigment particles, a charge control agent, and a non-polar liquid,
each microcell of the plurality of microcells (204) having a microcell opening (205), the sealing layer (206) spanning the microcell openings (205) of the plurality of microcells (204),
each microcell of the plurality of microcells (204) comprising a microcell bottom layer (210), a protrusion structure (217), microcell walls (212), a midplane, and a channel (215),
the microcell bottom layer (210) having a microcell bottom inside surface (211), the microcell bottom inside surface (211) comprising an exposed microcell bottom inside surface (211a) and an unexposed microcell bottom inside surface (211b),
the protrusion structure (217) having a protrusion base (218), a protrusion surface (221), a protrusion apex (219), and a protrusion height (220), the protrusion structure (217) consisting of an upper part and a lower part, the protrusion apex (219) being a point or a set of points of the protrusion structure (217), the point or the set of points having shorter distance from the microcell opening (205) than all other points of the protrusion structure (217), the protrusion height (220) being the distance between the protrusion base (218) and the protrusion apex (219), the protrusion surface (221) being the surface of the protrusion structure (217) that is in contact with the electrophoretic medium (209) not including the protrusion apex (219),
the midplane being a plane that is parallel to the sealing layer, the midplane being located between the protrusion base and the protrusion apex, the distance between the midplane and the protrusion base being equal to half of the protrusion height, the midplane dividing the protrusion structure (217) into the lower part and the upper part,
the microcell walls (212) having a microcell inside wall surface (213) and a microcell wall upper surface (214), the microcell inside wall surface (213) being a surface of the microcell walls (212) of a microcell that is in contact with the electrophoretic medium (209), the microcell wall upper surface (214) being a surface of the microcell walls (212) of a microcell that is in contact with the sealing layer (206), the protrusion base (218) and the exposed microcell bottom inside surface (211a) having an intersection, the microcell inside wall surface (213) and the exposed microcell bottom inside surface (211a) having an intersection,
the channel (215) having a channel height (216), an inner perimeter (225), and an outer perimeter (226), the channel height (216) being half of the protrusion height (220), the inner perimeter (225) being the intersection of the protrusion base (218) and the exposed microcell bottom inside surface (211a), the outer perimeter (226) being the intersection of the microcell inside wall surface (213) and the exposed microcell bottom inside surface (211a), the unexposed microcell bottom inside surface (211b) being a part of the microcell inside surface (211) that is in contact with the protrusion base (218),
the channel (215) being a volume confined between the exposed microcell bottom inside surface (211a), the protrusion surface (221), the microcell inside wall surface (213), and the midplane,
the variable light transmission device having a first outside surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207),
the exposed microcell bottom inside surface (211a) having an x dimension and a y dimension for a point of the outer perimeter (226) of the channel, the x dimension being defined by a line that includes the line segment that corresponds to the shortest distance between the point of the outer perimeter (226) of the channel and the inner perimeter (225) of the channel, the y dimension being orthogonal to the x dimension, both x dimension and y dimension being on a plane of the exposed microcell bottom inside surface (211a),
wherein application of a first electric field between the first light transmissive electrode layer (202) and the second light transmissive electrode layer (207) via a first waveform causes movement of the plurality of first type of electrically charged pigment particles towards the channel (215), resulting in switching of the variable light transmission device to an open optical state, the plurality of first type of electrically charged pigment particles in the open optical state being arranged in the channel (215) to achieve varied optical density or varied visible light spectrum of the variable light transmission device across the x dimension of the exposed microcell bottom inside surface (211a),
wherein application of a second electric field between the first light transmissive electrode layer (202) and the second light transmissive electrode layer (207) via a second waveform causes movement of the plurality of first type of electrically charged pigment particles towards the first light transmissive electrode layer (202) resulting in the switching of the variable light transmission device to a closed optical state, the closed optical state having lower percent transparency than the open optical state.

2. The variable light transmission device of claim 1, wherein the protrusion structure of a microcell is a geometric solid selected from the group consisting of
(a) a polygonal pyramid, the polygonal pyramid having an apex and polygon base, the polygon apex being the protrusion apex, the polygon base having 3-20 sides, and the polygon base being the protrusion base of the protrusion structure;
(b) a polygonal pyramid on a polygonal prism, the polygonal pyramid having an apex and a polygon base, the polygonal prism having a first polygon base and a second polygon base, the polygonal pyramid apex being the protrusion apex, the polygon base of the polygonal pyramid being in contact with the first polygon base of the polygonal prism, the second polygon base of the polygonal prism being the protrusion base of the protrusion structure, the polygon base of the polygonal pyramid and the first and second polygon bases of the polygonal prism having the same number of sides, the polygon base of the polygonal pyramid and the first and second polygon bases of the polygonal prism having 3-20 sides;
(c) a cone having an apex and a base, the apex of the cone being the protrusion apex, the base of the cone being circular, and the base of the cone being the protrusion base;
(d) a cone on a cylinder, the cone having an apex and a base, the base of the cone being circular, the apex of the cone being the protrusion apex, the cylinder having a first base and a second base, the first base and the second base being circular, the base of the cone being in contact with the first base of the cylinder, and the second base of the cylinder being the protrusion base of the protrusion structure;
(c) a frustum of polygonal pyramid, the frustum of polygonal pyramid having a first polygon base and a second polygon base, the first polygon base having a smaller area than the second polygon base, the first polygon base being the protrusion apex and the second polygon base being the protrusion base, the first and second polygon bases of the frustrum of the polygonal pyramid having 3-20 sides;
(f) a frustum of polygonal pyramid on an polygonal prism, the frustum of polygonal prism having a first polygon base and a second polygon base, the first polygon base of the frustum of polygonal pyramid having a smaller area than the second polygon base of the frustum of polygonal pyramid, the polygonal prism having a first polygon base and a second polygon base, the first polygon base of the frustum of polygonal pyramid being the protrusion apex, the second polygon base of the polygonal pyramid being in contact with the first polygon base of the polygonal prism, the second polygon base of the polygonal prism being the protrusion base, the first and second polygon bases of the frustum of polygonal pyramid and the first and second polygon bases of the polygonal prism having the same number of sides, the first and second polygon bases of the frustum of polygonal pyramid and the first and second polygon bases of the polygonal prism the first polygon base having 3-20 sides;
(g) a frustum of cone, the frustum of cone having a first base and a second base, the first base of the frustum of cone having a smaller area than the second base of the frustum of cone, the first base of the frustum of cone being the protrusion apex and the second base of the frustum of cone being the protrusion base, the first and second bases of the frustrum of the cone being circular;
(h) a frustum of cone on a cylinder, the frustum of cone having a first base and a second base, the first base of the frustum of cone having a smaller area than the second base of the frustum of cone, the cylinder having a first base and a second base, the first and second bases of the frustum of cone and the first and second bases of the cylinder being circular, the first base of the frustum of cone being the protrusion apex, the second base of the frustum of cone being in contact with the first base of the cylinder, and the second base of the cylinder being the protrusion base;
(i) a polygonal pyramid on a frustum of polygonal pyramid, the polygonal pyramid having an apex and a polygon base, the frustum of polygonal pyramid having a first polygon base and a second polygon base, the first base having smaller area than the second base, the polygonal pyramid apex being the protrusion apex, the polygon base of the polygonal pyramid being in contact with the first polygon base of the frustum of polygonal pyramid, the second polygon base of the frustum of polygonal pyramid being the protrusion base of the protrusion structure, the polygon base of the polygonal pyramid and the first and second polygon bases of the polygonal prism having the same number of sides, the polygon base of the polygonal pyramid and the first and second polygon bases of the frustum of polygonal pyramid having 3-20 sides;
(j) a cone on a frustum of cone, the cone having an apex and a base, the base of the cone being circular, the apex of the cone being the protrusion apex, the frustum of cone having a first base and a second base, the first base and the second base being circular, the first base having smaller area than the second base, the base of the cone being in contact with the first base of the frustum of cone, and the second base of the frustum of cone being the protrusion base of the protrusion structure;
(k) a first frustum of polygonal pyramid on a second frustum of polygonal pyramid, the first frustum of polygonal pyramid having a first polygon base and a second polygon base, the first polygon base of the first frustum of polygonal pyramid having a smaller area than the second polygon base of the first frustum of polygonal pyramid, the second frustum of polygonal pyramid having a first polygon base and a second polygon base, the first polygon base of the second frustum of polygonal pyramid having smaller area than the second polygon base of the second frustum of polygonal pyramid, the first polygon base of the first frustum of polygonal pyramid being the protrusion apex, the second polygon base of the first frustum of polygonal pyramid being in contact with the first polygon base of the second frustum of polygonal pyramid, the second polygon base of the second frustum of polygonal pyramid being the protrusion base, the first and second polygon bases of the first frustum of polygonal pyramid and the first and second polygon bases of the second frustum of polygonal pyramid having the same number of sides, the first and second polygon bases of the first frustum of polygonal pyramid and the first and second polygon bases of the second frustum of polygonal pyramid having 3-20 sides, the slope of the first frustum of polygonal pyramid being larger than the slope of the second frustum of polygonal pyramid or the slope of the first frustum of polygonal pyramid being smaller than the slope of the second frustum of polygonal pyramid;
(l) a first frustum of cone on a second frustum of cone, the first frustum of cone having a first base and a second base, the first base of the first frustum of cone having a smaller area than the second base of the first frustum of cone, the second frustum of cone having a first base and a second base, the first base of the second frustum of cone having smaller area than the second base of the second frustum of cone, the first base of the first frustum of cone being the protrusion apex, the second base of the first frustum of cone being in contact with the first base of the second frustum of cone, the second base of the second frustum of cone being the protrusion base, the first and second bases of the first frustum of cone and the first and second bases of the second frustum of cone having the same number of sides, the first and second bases of the first frustum of cone and the first and second bases of the second frustum of cone having 3-20 sides, the slope of the first frustum of cone being larger than the slope of the second frustum of cone or the slope of the first frustum of cone being smaller than the slope of the second frustum of conc.

3. The variable light transmission device of claim 2, wherein, (a) if the protrusion structure is a polygonal pyramid, the polygonal pyramid has a slope of from 5 degrees to 20 degrees; (b) if the protrusion structure is a polygonal pyramid on a polygonal prism, the polygonal pyramid has a slope of from 5 degrees to 20 degrees; (c) if the protrusion structure is a cone, the cone has a slope of from 5 degrees to 20 degrees; (d) if the protrusion structure is a cone on a cylinder, the cone has a slope of from 5 degrees to 20 degrees; (e) if the protrusion structure is a frustum of polygonal pyramid, the frustum of polygonal pyramid has a slope of from 5 degrees to 20 degrees; (f) if the protrusion structure is a frustum of polygonal pyramid on an polygonal prism, the frustum of polygonal pyramid has a slope of from 5 degrees to 20 degrees; (g) if the protrusion structure is a frustum of cone, the frustum of cone has a slope of from 5 degrees to 20 degrees; (h) if the protrusion structure is a frustum of cone on a cylinder, the frustum of cone has a slope of from 5 degrees to 20 degrees; (i) if the protrusion structure is a polygonal pyramid on a frustum of polygonal pyramid, the polygonal pyramid has a slope of from 5 degrees to 20 degrees, and the frustum of polygonal pyramid has a slope of from 5 degrees to 20 degrees; (j) if the protrusion structure is a cone on a frustum of cone, the cone has a slope of from 5 degrees to 20 degrees and the frustum of cone has a slope of from 5 degrees to 20 degrees; (k) if the protrusion structure is a first frustum of polygonal pyramid on a second frustum of polygonal pyramid, the first frustum of polygonal pyramid has a slope of from 5 degrees to 20 degrees and the second frustum of polygonal pyramid has a slope of from 5 degrees to 20; (l) if the protrusion structure is a first frustum of cone on a second frustum of cone, the first frustum of cone has a slope of from 5 degrees to 20 degrees and the second frustum of cone has a slope of from 5 degrees to 20.

4. The variable light transmission device of claim 1, wherein the angle between the microcell inside wall surface and the microcell bottom inside surface is larger than 90 degrees, and wherein the combination of the channel and the lower part of the protrusion structure is a geometric solid selected from the group consisting of (a) a cylinder, (b) a cone, (c) a polygonal pyramid having a polygon base, the polygon base having from 3 to 20 sides, (d) a polygonal prism, the polygonal prism having two polygon bases, the polygon bases having from 3 to 20 sides, (e) a frustum of cone, and (f) a frustum of polygonal pyramid, the frustum of polygonal pyramid having a first and a second bases, the first and second bases being polygons having from 3 to 20 sides.

5. The variable light transmission device of claim 1, wherein the plurality of first type of electrically charged pigment particles in an open optical state are arranged in a channel of a microcell with a horizontal distribution that is reduced across the x dimension of the exposed microcell bottom inside surface (211a) from the outer perimeter to the inner perimeter of the channel of the microcell.

6. The variable light transmission device of claim 5, wherein the horizontal distribution is gradually reduced across the x dimension of the microcell bottom inside surface (211a) from the outer perimeter to the inner perimeter of the channel of the microcell.

7. The variable light transmission device of claim 6, wherein the arrangement of the plurality of first type of electrically charged pigment particles in an open optical state is achieved via the application of an electric field between the first light transmissive electrode layer (202) and the second light transmissive electrode layer (207) that causes movement of the plurality of first type of electrically charged pigment particles towards the second light transmissive electrode layer (207) with a velocity, the velocity having a lateral component.

8. The variable light transmission device of claim 1, wherein the electrophoretic medium (209) comprises a plurality of second type of electrically charged pigment particles, each of the plurality of first type of electrically pigment particles having a first charge polarity, each of the plurality of second type of electrically charged pigment particles having a second charge polarity, wherein the first charge polarity is the same charge polarity as the second charge polarity.

9. The variable light transmission device of claim 8, wherein the first type of electrically charged pigment particles has different zeta potential from the second type of electrically charged pigment particles.

10. The variable light transmission device of claim 8, wherein each of the plurality of first type of electrically charged pigment particles and each of the plurality of second type of electrically charged pigment particles are positive, and wherein the zeta potential of the first type of electrically charged pigment particles is higher than the zeta potential of the second type of electrically charged pigment particles.

11. The variable light transmission device of claim 8, wherein each of the plurality of first type of electrically charged pigment particles and each of the plurality of second type of electrically charged pigment particles are negative, and wherein the zeta potential of the first type of electrically charged pigment particles is lower than the zeta potential of the second type of electrically charged pigment particles.

12. The variable light transmission device of claim 8, wherein each of the plurality of first type of electrically charged pigment particles comprises a first absorbing pigment, and each of the plurality of second type of electrically charged pigment particles comprises a second light absorbing pigment, the plurality of first type of electrically charged pigment particles having a first absorption spectrum, the plurality of second type of electrically charged pigment particles having a second absorption spectrum, the first absorption being different from the second absorption spectrum.

13. The variable light transmission device of claim 8, wherein each of the plurality of first type of electrically charged pigment particles comprises a light absorbing pigment and each of the plurality of second type of electrically charged pigment particles comprises a light reflective pigment.

14. The variable light transmission device of claim 13, wherein each of the plurality of first type of electrically charged pigment particles comprises a black pigment and each of the plurality of second type of electrically charged pigment particles comprises a white pigment.

15. The variable light transmission device of claim 8, wherein the plurality of first type of electrically charged pigment particles have an average particle size that is smaller than the average particle size of the plurality of second type of electrically charged pigment particles.

16. The variable light transmission device of claim 8, wherein, in an open optical state, the plurality of first type of electrically charged pigment particles are arranged in a channel of a microcell with a horizontal distribution that is reduced across the x dimension of the exposed microcell bottom inside surface from the outer perimeter to the inner perimeter of the channel of the microcell, and the plurality of second type of electrically charged pigment particles are arranged in the channel of the microcell with a horizontal distribution that is increased across the x dimension of the exposed microcell bottom inside surface from the outer perimeter to the inner perimeter of the channel of the microcell.

17. The variable light transmission device of claim 1, wherein the second waveform comprises at least one positive voltage and at least one negative voltage.

18. The variable light transmission device of claim 1, wherein the movement of the plurality of first type of electrically charged pigment particles towards the first light transmissive electrode layer (202), which causes the closed optical state, has a velocity, the velocity having a lateral component.

19. The variable light transmission device of claim 18, wherein the second waveform comprises an AC waveform, the AC waveform having a duty cycle of from 5% to 45%.

20. The variable light transmission device of claim 18, wherein the second waveform comprises a DC-offset waveform, which is formed by a superposition of a DC voltage component and an AC waveform.
